(19) United States
(12) Patent Application Publication
(10) Pub. No.: US 2015/0373369 A1
(43) Pub. Date: Dec. 24, 2015

(54) ANAMORPHIC STRETCH IMAGE COMPRESSION

(71) Applicant: THE REGENTS OF THE UNIVERSITY OF CALIFORNIA, Oakland, CA (US)

(72) Inventors: Bahram Jalali, Los Angeles, CA (US); Mohammad H. Asghari, Los Angeles, CA (US)

(73) Assignee: THE REGENTS OF THE UNIVERSITY OF CALIFORNIA, Oakland, CA (US)

(21) Appl. No.: 14/749,628

(22) Filed: Jun. 24, 2015

Related U.S. Application Data
(63) Continuation of application No. PCT/US2013/073426, filed on Dec. 5, 2013.
(60) Provisional application No. 61/888,867, filed on Oct. 9, 2013.
(60) Provisional application No. 61/867,515, filed on Aug. 19, 2013.
(60) Provisional application No. 61/839,444, filed on Jun. 26, 2013.
(60) Provisional application No. 61/746,244, filed on Dec. 27, 2012.

(51) Int. Cl. H04N 19/59; H04N 19/136; H04N 19/80; H04N 19/132

(52) U.S. Cl. CPC H04N 19/59; H04N 19/132; H04N 19/136; H04N 19/80

(57) ABSTRACT

A feature-selective compression method and system are described which uses a transformation causing feature-selective stretching of the image being compressed. As a result, additional samples are allocated to sharp features where they are needed, and less to coarse features where they are redundant. The method can be applied to still and video images, whether they are monochrome or color images or 3D images, and operates in open-loop fashion and does not require prior knowledge of the image. The method can be applied by itself or combined with other types of compression (i.e., JPEG, WebP) to further compress the image.

### CROSS-REFERENCE TO RELATED APPLICATIONS

This application is a 35 U.S.C. §111(a) continuation of PCT international application number PCT/US2013/073426 filed on Dec. 5, 2013, incorporated herein by reference in its entirety, which claims priority to, and the benefit of, U.S. provisional patent application Ser. No. 61/746,244 filed on Dec. 27, 2012, incorporated herein by reference in entirety, and which claims priority to, and the benefit of, U.S. provisional patent application Ser. No. 61/867,515 filed on Aug. 19, 2013, incorporated herein by reference in its entirety, and which claim priority to, and the benefit of, U.S. provisional patent application Ser. No. 61/839,444 filed on Jun. 26, 2013, incorporated herein by reference in its entirety, and which claims priority to, and the benefit of, U.S. provisional patent application Ser. No. 61/888,867 filed on Oct. 9, 2013, incorporated herein by reference in its entirety. Priority is claimed to each of the foregoing applications.

The above-referenced PCT international application was published as PCT International Publication No. WO 2014/105385 on Jul. 3, 2014, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to digital image compression, and more particularly to compressing a digital image utilizing a feature selective image compression technique.

2. Description of Related Art

Image information, including still images and video images, continues to proliferate, in particular image content communicated over the internet. The difficulties involved with communicating and/or storing the massive volume of image data is exacerbated by the ever-increasing number of pixels generated by camera image sensors (in still and/or video cameras). Image compression is a critical process in dealing with the storage and transmission of high resolution images and video. In addition, other fields, including medical imaging, have similar challenges regarding communication and storage of forms of image data.

One common form of image compression is JPEG, which utilizes a lossy form of compression based on the discrete cosine transform (DCT) and adaptive quantization. The lossless JPEG mode attempts to mitigate the information loss, however it yields a level of compression which is much lower than that of the JPEG standard.

Warped Discrete Cosine Transform (WDCT) is a frequency-dependent DCT algorithm that has been proposed for use in JPEG. By warping the frequency axes, WDCT attempts to achieve superior compression ratio. However, utilizing WDCT has similar draw backs as found with JPEG and has even been embedded in some versions of JPEG, albeit it has not been widely used.

Compressive sensing is a popular technique that can represent sparse images using fewer samples than in traditional methods. It relies on sparsity of the starting image, random sampling and numerical optimization to recover the image. Typically, the image is sampled multiple times with random sample patterns and is recovered with computationally intensive iterative algorithms. While it is a promising approach, it relies on large amounts of computation, and hence does not lend itself to real-time streaming operation, in particular at high frame rates.

Accordingly, a need exists for an enhanced image encoding apparatus and method which provides increased levels of image compression for a given bit budget.

### BRIEF SUMMARY OF THE INVENTION

A method for image compression is introduced which performs feature selective compression (FSC) in response to performing a reshaping followed by down-sampling during compression, and interpolation followed by complex amplitude recovery and inverse reshaping during decompression. The reshaping is preferably performed utilizing a generalized anamorphic stretch transform (gAST), subsets of which are referred to as an S-transform, anamorphic spectral transform (AST), and anamorphic Stretch Transform (AST).

The mathematical transformation of the image leads to more efficient digital representation. Substantial compression is achieved by applying this mathematical transformation to the image that intentionally “warps” the image to cause a “feature selective stretch.” A transform reshapes the image prior to performing uniform or nonuniform re-sampling. The transform is performed so that sharp features experience a higher sampling density than coarse features. Conceptually this can be thought of as a warped stretch transformation whereby, sharp features are essentially stretched more than coarse features. This is achieved through a mathematical reshaping of the image and not through modification to the sampling process. Thus, during compression, reshaping is performed followed by down-sampling. Decompression includes amplitude recovery algorithms and phase recovery algorithms and is performed by resampling (up-sampling), followed by complex amplitude recovery and inverse reshaping.

The resulting compression technique allocates more samples to sharper features in the image, where they are needed, and fewer samples to coarse features where they would be redundant. The technique can be utilized by itself for compression or in combination with other compression techniques. The new technique facilitates storage, transmission and processing of images and solves the ‘big data’ problem in emerging systems.

The feature selective compression (FSC) is preferably performed digitally and can be implemented offline, or online, For example, FSC can be performed with one or more computer processors such as microcontrollers, or digital hardware such as an FPGA located at the backend of the image sensor. The all-digital implementation lends itself to a compact and portable form factor and a robust solution. FSC can also be implemented in the analog domain, or in a combination of analog and digital.

Feature selective compression (FSC) can be used by itself, or can be combined with other compression techniques, such as JPEG, WebP, entropy encoding and other image and video compression techniques to provide extremely high compression factors. Since FSC is an open loop system, not requiring adaptivity, feedback or control signals, a large field of view can be monitored with higher resolution in regions having finer features. Used with a giga-pixel camera, a large field of view can be sampled with high resolution throughout, while overcoming the problems associated with this ‘explosion of data’ which causes problems in transmission, storage and processing. The present invention solves this problem by compressing giga-pixel images without loss of fidelity.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a graph of conventional sampling rate selection in response to spatial frequency.

FIG. 2 is a block diagram of utilizing feature selective compression (FSC) according to an embodiment of the present invention.

FIG. 3 is a graph depicting a simplified illustration of image information being compressed and uncompressed according to feature selective compression (FSC) according to an embodiment of the present invention.

FIG. 4 is a block diagram of performing phase recovery during decompression according to an embodiment of the present invention.

FIG. 5 is a block diagram of feature selective compression (FSC) and decompression according to an embodiment of the present invention, shown utilized in combination with a secondary compression method.

FIG. 6 is a block diagram of feature selective compression (FSC) and decompression according to an embodiment of the present invention, shown utilized in combination with entropy encoding and decoding.

FIG. 7 is a block diagram of feature selective compression (FSC) and decompression according to an embodiment of the present invention, shown utilized in combination with JPEG encoding and decoding.

FIG. 8 is a block diagram of feature selective compression (FSC) utilizing a generalized anamorphic stretch transform (gAST) according to an embodiment of the present invention.

FIG. 9 is a block diagram of anamorphic space-bandwidth image compression according to an embodiment of the present invention.

FIG. 10 is a block diagram of anamorphic space-bandwidth image decompression according to an embodiment of the present invention.

FIG. 11A and FIG. 11B are block diagrams of anamorphic video compression performed during video encoding according to embodiments of the present invention.

FIGS. 12A and 12B are graphs of 1D and 2D local frequency profiles utilized according to embodiments of the present invention.

FIGS. 13A and 13B are graphs of image auto-correlation before and after utilizing feature selective compression (FSC) according to an embodiment of the present invention.

FIGS. 14A and 14B are graphs of image spectrum before and after utilizing feature selective compression (FSC) according to an embodiment of the present invention.

FIGS. 15A and 15B are graphs of spatial bandwidth before and after utilizing feature selective compression (FSC) according to an embodiment of the present invention.

FIG. 16A and FIG. 16B are graphs of a phase derivative profile for performing anamorphic stretch/spectral transform (AST) according to an embodiment of the present invention in different coordinate systems, seen as Cartesian in FIG. 16A and polar in FIG. 16B.

FIG. 17A and FIG. 17B are an original image and a stretch transformed image (double-decker bus) according to an embodiment of the present invention.

FIG. 18A through FIG. 18C are an original image (double-decker bus) in FIG. 18A, the image after conventional down-sampled compression in FIG. 18B, and the image after feature selective compression in FIG. 18C according to an embodiment of the present invention.

FIG. 19A through FIG. 19C are images that compare textual elements found in the images of FIG. 18A through 18C for the original image, down-sampled image, and feature selective compression according to an embodiment of the present invention.

FIG. 20A and FIG. 20B compare images (double-decker bus) resulting from JPEG compression in FIG. 20A, and feature selective compression according to an embodiment of the present invention in combination with JPEG compression in FIG. 20B.

FIG. 21A and FIG. 21B compare textual elements found in the images of FIG. 20A and FIG. 20B for JPEG compression, and feature selective compression according to an embodiment of the present invention utilized in combination with JPEG compression.

FIG. 22A through FIG. 22C are images (actress) comparing an original image in FIG. 22A, with a JPEG compressed image in FIG. 22B, and a feature selective compression utilized in combination with JPEG in FIG. 22C according to an embodiment of the present invention.

FIG. 23A through FIG. 23C are images (group of peppers) comparing an original image in FIG. 23A, JPEG compressed image in FIG. 23B, and feature selective compression utilized with JPEG in FIG. 23C according to an embodiment of the present invention.

FIG. 24A and FIG. 24B are images (ocean liner) comparing a JPEG compressed image in FIG. 24A, with a feature selective compression utilized with JPEG in FIG. 24B according to an embodiment of the present invention.

FIG. 25A and FIG. 25B are images (ship convoy) comparing a JPEG compressed image in FIG. 25A, with an image utilizing feature selective compression in combination with JPEG in FIG. 25B according to an embodiment of the present invention.

FIG. 26A and FIG. 26B are images (aerial city view) comparing a JPEG compressed image in FIG. 26A, with an image utilizing feature selective compression in combination with JPEG in FIG. 26B according to an embodiment of the present invention.

FIG. 27A and FIG. 27B are images (shoreline) comparing a JPEG compressed image in FIG. 27A, with an image utilizing feature selective compression in combination with JPEG in FIG. 27B according to an embodiment of the present invention.

FIG. 28 is an original image (large crowd of people) utilized for comparing JPEG compression to feature selective compression utilized with JPEG according to an embodiment of the present invention, as detailed in FIG. 29A through FIG. 34B.

FIG. 29A and FIG. 29B are an image comparison of JPEG compression in FIG. 29A, with feature selective compression utilized with JPEG according to an embodiment of the present invention in FIG. 29B, from a section of the original image seen in FIG. 28.

FIG. 30A and FIG. 30B are an image comparison of JPEG compression in FIG. 30A, with feature selective compression utilized in combination with JPEG according to an embodiment of the present invention in FIG. 30, from a section of the original image seen in FIG. 28.

FIG. 31A and FIG. 31B are an image comparison of JPEG compression in FIG. 31A, with feature selective compression utilized with JPEG according to an embodiment of the present invention in FIG. 31B, from a section of the original image seen in FIG. 28.

FIG. 32A and FIG. 32B are an image comparison of JPEG compression in FIG. 32A, with feature selective compression utilized with JPEG according to an embodiment of the present invention in FIG. 32B, from a section of the original image seen in FIG. 28.

FIG. 33A and FIG. 33B are an image comparison of JPEG compression in FIG. 33A, with feature selective compression utilized with JPEG according to an embodiment of the present invention in FIG. 33B, from a section of the original image seen in FIG. 28.

FIG. 34A and FIG. 34B are an image comparison of JPEG compression in FIG. 34A, with feature selective compression utilized with JPEG according to an embodiment of the present invention in FIG. 34B, from a section of the original image seen in FIG. 28.

FIG. 35A and FIG. 35B are medical images (cardiac tissue) comparing JPEG compression in FIG. 35A, with feature selective compression utilized with JPEG according to an embodiment of the present invention in FIG. 35B.

FIG. 36A and FIG. 36B are medical images (lung tissue) comparing JPEG compression in FIG. 32A, with feature selective compression utilized with JPEG according to an embodiment of the present invention in FIG. 36B.

FIG. 37A and FIG. 37B are images (double-decker bus) comparing results after WebP compression in FIG. 37A, with feature selective compression utilized in combination with WebP compression according to an embodiment of the present invention in FIG. 37B.

FIG. 38A and FIG. 38B are images comparing textual portions from compressed images of FIG. 37A and FIG. 37B.

FIG. 39A and FIG. 39B are images (actress) comparing WebP compression in FIG. 39A, with feature selective compression utilized in combination with WebP compression according to an embodiment of the present invention in FIG. 39B.

FIG. 40A and FIG. 40B are images (group of peppers) comparing WebP compression in FIG. 40A, with feature selective compression utilized in combination with WebP compression according to an embodiment of the present invention in FIG. 40B.

### DETAILED DESCRIPTION OF THE INVENTION

1. Introduction.

Image data rate in conventional image processing is related to the number of pixels needed to represent an image, and is given by twice the highest frequency component of the image (i.e., sharpest transitions in intensity, and color hue), the so-called Nyquist rate. However, in arriving at the present invention, it has been considered that this paradigm makes inefficient use of the available samples because frequency components below the Nyquist rate are over-sampled whereas frequency components above it, if any, are under sampled. As a result, the sampled image data size is much larger than necessary. Due to this inherent inefficiency in Nyquist sampling, massive amounts of redundant data is generated causing bottlenecks in image data transfer, storage, and processing. Either the system cannot support the data rate, or the computational complexity and battery power required for processing the massive volumes of digital data become prohibitively large. Hence, there is need for methods and systems that can efficiently adapt the images to match the underlying system resource (data rate and complexity) constraints.

Traditional lossy techniques for image adaptation to meet resource constraints involve reducing the sampling rate of the original image stream using down-sampling, low-pass filtering, quantization, and so forth. Down-sampling (low-pass filtering) involves evenly discarding samples of the data to reduce the sampling rate so it does not achieve feature selective sampling. Down-sampling also leads to loss of vital information. Quantization involves mapping image samples onto a coarser version that requires fewer hits to represent them.

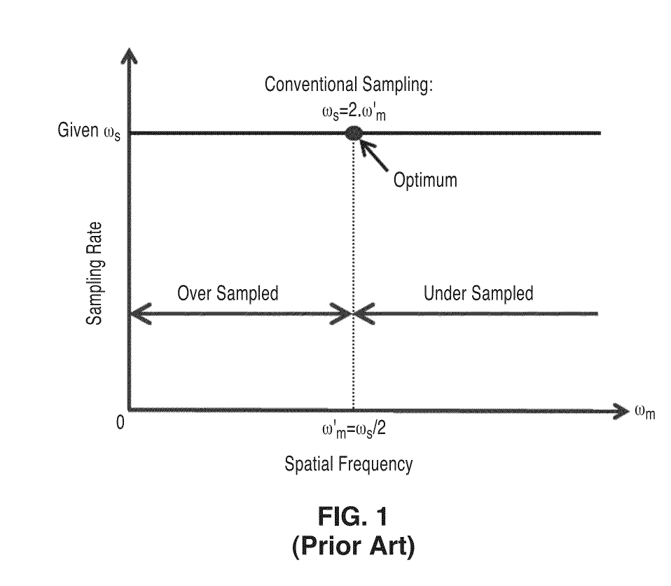

FIG. 1 depicts conventional uniform sampling of images which makes inefficient use of samples because sharp features are over-sampled whereas coarse features are often under-sampled. This situation has been recognized and addressed in the present invention. Considering FIG. 1, one can see that sampling rate in conventional coding is set to an optimized value seen as ωₛ=2·ω′ₘ which is a tradeoff based on spatial frequency ω′ₘ=ωₛ/2 of the features. As a result of this tradeoff, features having a spatial frequency below ωₛ=2·ω′ₘ are over sampled, while features having a spatial frequency above ωₛ=2·ω′ₘ are under sampled. This inefficient image representation causes the image data size to be much larger than necessary and creates a “big data” problem. Bottlenecks then arise in the storage, transmission and processing of images.

To overcome the problems with conventional coding techniques, a feature-selective compression (FSC) is described for compression of still images and video images (including streaming video). FSC makes use of a generalized anamorphic stretch transform (gAST), which has subsets referred to as a feature-selective stretch transform (FST), and an anamorphic spectral/stretch transform (AST). During FSC, a feature-selective sampling (FSS) is performed of the image data in which the image is warped to generate a higher sampling rate at sharp features (high data content areas) than is utilized for coarse features.

2. Embodiments of Feature Selective Compression.

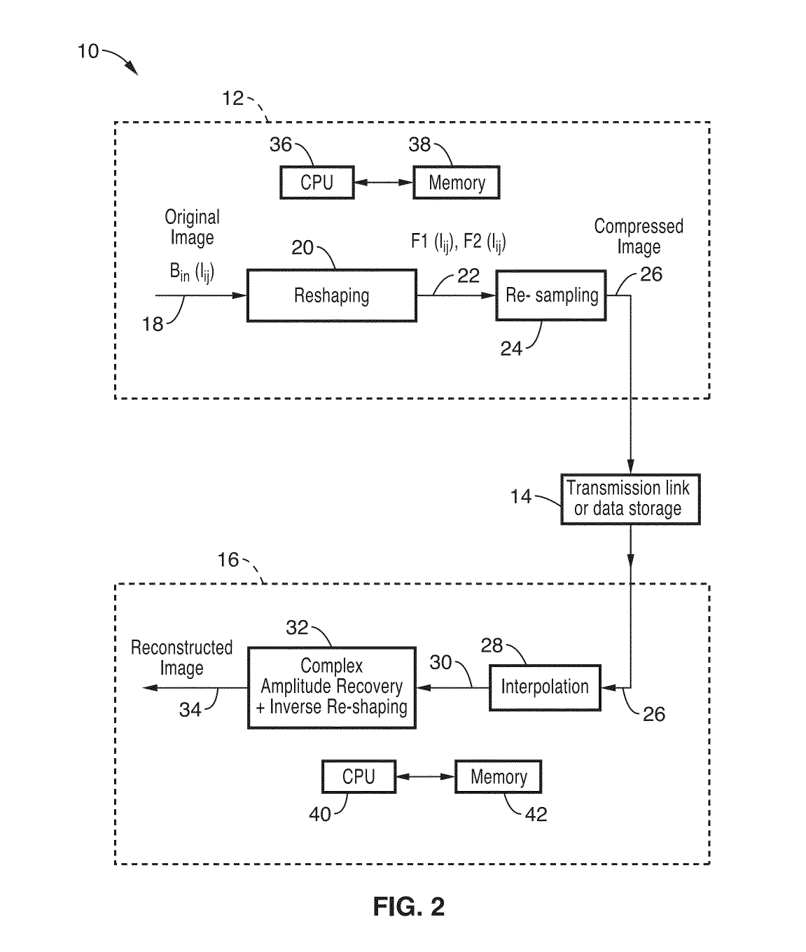

FIG. 2 illustrates an example embodiment 10 of FSC receiving an original image 18 Bᵢₙ (1ᵢⱼ) upon which reshaping 20 is performed to output an image F1(1ᵢⱼ); F2(1ᵢⱼ) 22, preferably utilizing a generalized anamorphic stretch transform (gAST) for re-sampling 24 and output of a compressed image 26. The output from this first compression technique 26 can be communicated and/or stored directly, or it may be utilized as input to other types of compression (e.g., JPEG, WebP, etc.) detailed in other embodiments. More particularly, original image Bᵢₙ (1ᵢⱼ) is received 18 within apparatus 12 and is reshaped 20 utilizing a feature selective transform, such as the generalized anamorphic stretch transform (gAST). It will be appreciated that original image brightness is represented by Bᵢₙ(1ᵢⱼ) where 1ᵢⱼ represents the spatial variables x and y.

During playback in decompressor 16, the FST compressed image data received from a transmission link or data storage 14, is interpolated 28 to output intermediate image signal 30 upon which complex amplitude recovery and inverse reshaping is performed 32 to output reconstructed image 34.

By way of example and not limitation, the circuitry of the compressor (encoder) and decompressor (decoder) are seen including one or more computational elements, comprising a computer (CPU) 36, 40, and associated memory 38, 42 for performing programming for executing compression and decompression steps which incorporate feature selective compression and down-sampling, as well as interpolation and recovery and inverse reshaping according to the invention. The present invention is non-limiting with regard to type and number of processors and memory. It should also be appreciated that the memory (e.g., computer readable media) in embodiments of the present invention are “non-transitory”, any may comprise any and all forms of computer-readable media, with the sole exception being a transitory, propagating signal. Accordingly, the invention may comprise any form of memory, including those which are random access (e.g., RAM), require periodic refreshing (e.g., DRAM), those that degrade over time (e.g., EEPROMS, disk media), or that store data for only short periods of time and/or only in the presence of power, with the only limitation being that the term “computer readable media” is not applicable to an electronic signal which is transitory. In addition, it should be appreciated that all or a portion of the processing may be performed by logic devices, such as FPGAs, and other digital devices which do not per se execute programming. Still further, portions of the processing can be performed by analog elements (e.g., lenses, spatial light modulators, diffraction gratings, thin film/diffractive mirrors, lenses as well as other optical elements and combinations thereof). It should be recognized that element selection described above is generally applicable for each of the embodiments of the present invention.

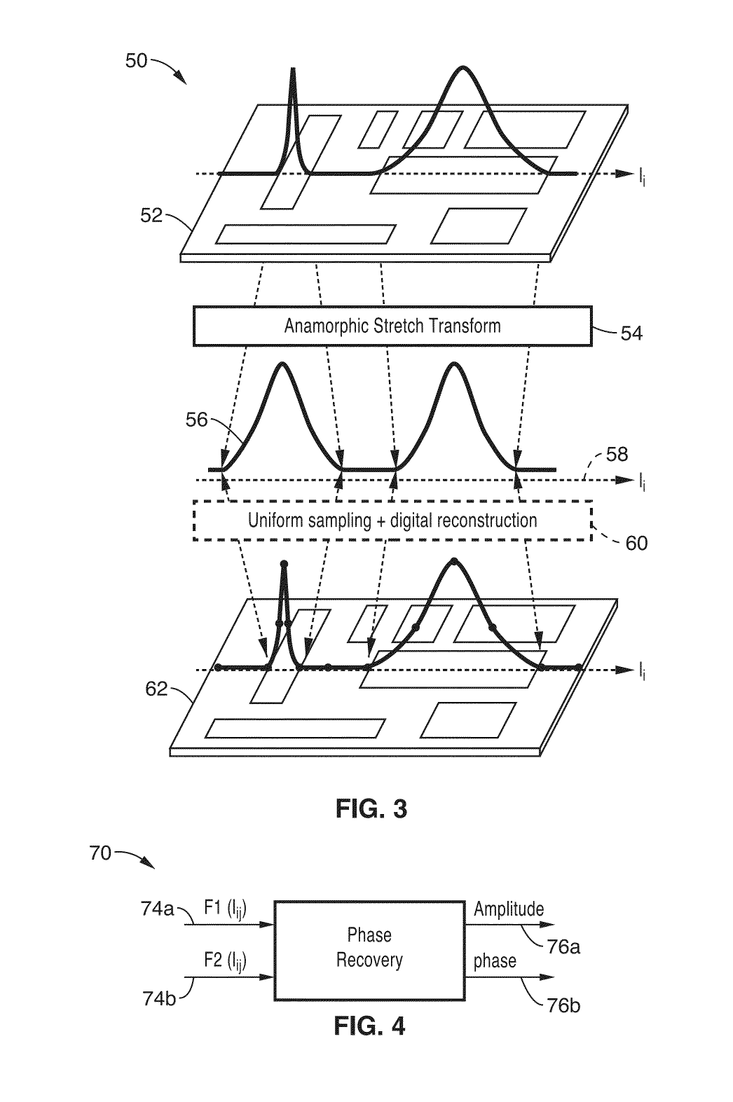

FIG. 3 illustrates the general concept 50 of feature selective compression. Conceptually, feature selective compression (FSC) can be considered a form of nonuniform stretch operation where sharp features are selectively stretched while coarse features experience negligible change. This stretching is achieved through a mathematical reshaping of the image and not through modification to the sampling process. It should also be appreciated that FSC does not require a-priori knowledge of the image, such as in setting parameters for operation. Using FSC methods of the present invention, the number of samples required to represent the image is minimized for a given image quality, or the image quality is improved for a given number of samples, or a combination thereof. Thus, FSC does not require computationally intensive algorithms and is hence amenable to fast real-time operation.

In the upper portion of the figure, one can see a representative image 52, overlaid by a ‘feature sharpness’ curve indicating the sharpness across one line 1ᵢ of pixels in the image. A curve 56 is shown in response to utilizing a feature selective transform 54 of image line 1ᵢ, in which each of the features now has approximately the same sharpness, and can be stored or transmitted 58. It should be appreciated that while the horizontal direction in image 52 is depicted as i, the orthogonal direction (out of the page in this view) can be considered the j direction through which the process would continue. During decoding, a substantially reverse process takes place 60 and results in a reconstructed image 62.

Reshaping comprises a feature selective stretching, in which sharp features are effectively stretched more than coarse features. This means that after the transformation more samples are allocated to sharp features than to coarse features, as was seen in FIG. 3. This stretching operation facilitates space-bandwidth compression. Mathematically, reshaping maps image brightness to two new parameters F1(1ᵢⱼ) and F2(1ᵢⱼ). As shown later, feature selective compression increases the spatial coherency of the image. Mathematically, reshaping can be described by a generalized anamorphic stretch transform (gAST) as follows:

$$gAST \{ {B}_{i n} ( {1}_{ij} ) \} ⇒ \{ \begin{matrix}F 1 ( {1}_{ij} ) = f ( \vert {\int }_{- ∞}^{∞} {e}^{j \cdot Φ ( {1}_{ij} - {1}_{ij}^{′} )} \cdot {B}_{i n} ( {1}_{ij}^{′} ) d {1}_{ij}^{′} \vert ) \\ F 2 ( {1}_{ij} ) = g ( \vert {\int }_{- ∞}^{∞} D ( {1}_{ij} - {1}_{ij}^{″} ) \cdot [ {\int }_{- ∞}^{∞} {e}^{j \cdot Φ ( {1}_{ij}^{″} - {1}_{ij}^{′} )} \cdot {B}_{i n} ( {1}_{ij}^{′} ) d {1}_{ij}^{′} ] d {1}_{ij}^{″} \vert )\end{matrix} \qquad ( 1 )$$

where F1(1ᵢⱼ) and F2(1ᵢⱼ) are transformed brightnesses, ∥ is the absolute operator, and f(x) and g(x) are arbitrary injective functions for x≧0. The e^{jΦ(l}^{ᵢⱼ}⁾ kernel describes the operation needed for feature selective stretch (FSS) described below, and the D(1ᵢⱼ) kernel performs phase discrimination and is used to map the phase into the brightness parameter F2(1ᵢⱼ).

FIG. 4 illustrates an example embodiment 70 of phase recovery during decompression showing receipt of transformed brightnesses F1(1ᵢⱼ) 74a and F2(1ᵢⱼ) 74b, into phase recovery block which outputs amplitude 76a and phase 76b. It will be appreciated that image decompression requires knowledge of the complex amplitude (amplitude and phase) of the transformed image. This can be determined from F1 and F2 using a phase recovery method, a number of which are known in the art (e.g., the STARS technique developed by the inventors).

Space-bandwidth product of the image is compressed when Φ(1ᵢⱼ) has a specific profile, in particular when the phase derivation defined as PD(1ᵢⱼ)=dΦ(1ᵢⱼ)/d1ᵢⱼ has a superlinear profile, (or alternatively when PD⁻¹(1ᵢⱼ) has a sublinear profile). One of the simplest, yet effective, such PD(1ᵢⱼ) profiles is the tangent function:

PD(1ᵢⱼ)=a·tan(b·1ᵢⱼ) (2)

where tan is a tangent function with a and b as arbitrary real-valued numbers. Using this function, a wide range of possible phase profiles can be generated. The phase derivative profile given by Eq. (2) can be utilized in different coordinate systems (e.g., Cartesian and polar). The phase derivate profile in the Cartesian coordinate system is given by:

PD(1ₓ,1_{y})=a₁·tan(b₁·1ₓ)+a₂·tan(b₂·1_{y}) (3)

whereas the phase derivative profile in the polar coordinate system is given by:

PD(1ᵣ,1_{φ})=a·tan(b·1ᵣ) (4)

After inventive reshaping, spatial coherency of the image is increased and its space-bandwidth product is compressed. The transformed image can now be down-sampled to reduce the data size. Reconstruction consists of interpolation following by inverse propagation through the reshaping algorithm.

The inventive method can also be combined with adaptive quantization and entropy encoding methods to further reduce the image data size. Also, the down-sampled image can be compressed further by following AST compression with other compression formats, including JPEG, WebP (i.e., a Google compression format) or customized algorithms employing nonuniform adaptive quantization and entropy encoding.

3. Feature Selective Stretch Transform.

At least one embodiment of the present invention utilizes a generalized anamorphic stretch transform gAST and assumes that f(x) and g(x) are the same functions and also that they have a polynomial profile, whereby this results in the following:

$$gAST \{ {B}_{i n} ( {1}_{ij} ) \} ⇒ \{ \begin{matrix}F 1 ( {1}_{ij} ) = {\vert {\int }_{- ∞}^{∞} {e}^{jΦ ( {1}_{ij} - {1}_{ij}^{′} )} \cdot {B}_{i n} ( {1}_{ij}^{′} ) d {1}_{ij}^{′} \vert}^{N} \\ F 2 ( {1}_{ij} ) = {\vert {\int }_{- ∞}^{∞} D ( {1}_{ij} - {1}_{ij}^{″} ) \cdot [ {\int }_{- ∞}^{∞} {e}^{jΦ ( {1}_{ij}^{″} - {1}_{ij}^{′} )} \cdot {B}_{i n} ( {1}_{ij}^{′} ) d {1}_{ij}^{′} ] d {1}_{ij}^{″} \vert}^{N}\end{matrix} \qquad ( 5 )$$

In the specific case that N=1, the approach is referred to as a feature selective stretch transform (FST), given as:

$$FST \{ {B}_{i n} ( {1}_{ij} ) \} ⇒ \{ \begin{matrix}F 1 ( {1}_{ij} ) = \vert {\int }_{- ∞}^{∞} {e}^{jΦ ( {1}_{ij} - {1}_{ij}^{′} )} \cdot {B}_{i n} ( {1}_{ij}^{′} ) d {1}_{ij}^{′} \vert \\ F 2 ( {1}_{ij} ) = \vert {\int }_{- ∞}^{∞} D ( {1}_{ij} - {1}_{ij}^{″} ) \cdot [ {\int }_{- ∞}^{∞} {e}^{j Φ ( {1}_{ij}^{″} - {1}_{ij}^{′} )} \cdot {B}_{i n} ( {1}_{ij}^{′} ) d {1}_{ij}^{′} ] d {1}_{ij}^{″} \vert\end{matrix} \qquad ( 6 )$$

However, it should be noted that the feature selective stretch operation is not limited only to the N=1 case, but is a general property of the present invention.

Considering the specific case in which N=2, this approach is referred to an anamorphic stretch transform (AST). AST has the property that it is also described in the frequency domain with a simple formula. Specifically the transformation and complex amplitude recovery is performed through the following equation as a transform that relates the original image brightness spectrum to two functions:

$$AST \{ {\tilde{B}}_{i n} ( {ω}_{ij} ) \} = \{ \begin{matrix}F 1 ( {ω}_{ij} ) = {\int }_{- ∞}^{∞} {\tilde{B}}_{i n} ( {ω}_{ij}^{′} ) \cdot {{\tilde{B}}_{i n}}^{*} ( {ω}_{ij}^{′} + {ω}_{ij} ) \cdot \\ {e}^{j ( ϕ ( {ω}_{ij}^{′} ) - ϕ ( {ω}_{ij}^{′} + {ω}_{ij} ) )} d {ω}_{ij}^{′} \\ F 2 ( {ω}_{ij} ) = {\int }_{- ∞}^{∞} {\tilde{B}}_{i n} ( {ω}_{ij}^{′} ) \cdot {{\tilde{B}}_{i n}}^{*} ( {ω}_{ij}^{′} + {ω}_{ij} ) \cdot \tilde{D} ( {ω}_{ij}^{′} ) \cdot \\ {\tilde{D}}^{*} ( {ω}_{ij}^{′} + {ω}_{ij} ) \cdot {e}^{j ( ϕ ( {ω}_{ij}^{′} ) - ϕ ( {ω}_{ij}^{′} + {ω}_{ij} ) )} d {ω}_{ij}^{′}\end{matrix} \qquad ( 7 )$$

In the above, ωᵢⱼ represents the two dimensional spatial frequency variables, \tilde{B}ᵢₙ(ωᵢⱼ) is the input image spectrum, φ(ωᵢⱼ) is the phase profile of the AST kernel responsible for space bandwidth compression, and \tilde{D}(ωᵢⱼ) is the frequency domain phase discriminator kernel. The first equation is the main transformation and because it operates on the image spectrum, it has been referred to as Anamorphic Spectral Transform (AST). The second equation is used for complex amplitude recovery as part of the image de-compression (reconstruction).

For image compression, the image space-bandwidth product must be also reduced. To find the proper AST kernel phase profile that reduces the image space-bandwidth product, a mathematical tool is required to describe the brightness spectrum and the image data size after it is subjected to the AST operation, this is referred to herein as a mapping operation and the map referred to as a modulation intensity distribution (MID) which has also been called the Anamorphic Spectral Distribution (ASD):

MID(ωᵢⱼ,1ᵢⱼ)=∫_{-∞}^{∞}\tilde{B}ᵢₙ(ωᵢⱼ′)\tilde{B}ᵢₙ*(ωᵢⱼ′+ωᵢⱼ)e^{j·[φ(ω}^{ᵢⱼ}^{′)-φ(ω}^{ᵢⱼ}^{′-ω}^{ᵢⱼ}^{)]}e^{j·ω}^{ᵢⱼ}^{′·l}^{ᵢⱼ}dωᵢⱼ′ (8)

In the above, 1ᵢⱼ denotes the two dimensional spatial variables. MID is a distribution function that provides a tool for engineering the space-bandwidth product through proper choice of φ(ωᵢⱼ). For space-bandwidth compression, the derivative of the AST kernel phase profile should be a sublinear function of frequency. Although a number of functions can be utilized according to the invention, an effective, and one of the simplest is the inverse tangent function:

$$PD ( {ω}_{ij} ) = \frac{d ϕ ( {ω}_{ij} )}{d {ω}_{ij}} = A \cdot {tan}^{- 1} ( B \cdot {ω}_{ij} ) , \qquad ( 9 )$$

where tan⁻¹ is inverse tangent operator and A and B are arbitrary numbers. A wide range of possible filter phase profiles can be generated using this function with only two parameters to represent them. Sharp features of the image are stretched in the spatial domain after performing AST, so that after resampling their allocated number of samples in the image is increased. However coarse features of the image are much less affected (or not affected at all) in this process. Accordingly, after transformation, more samples are allocated to sharp features of the image than coarse features, leading to feature selective sampling.

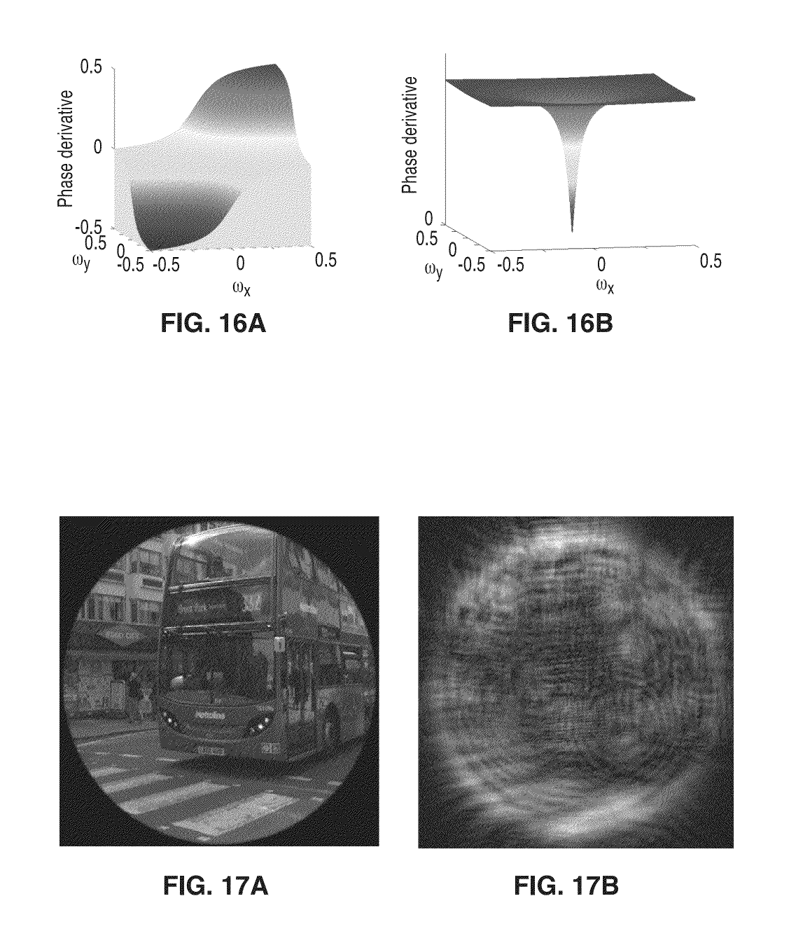

According to the specific image compression application for which AST is being used, the phase derivative profile given by Eq. (9) can be configured in different coordinate systems. FIG. 16A and FIG. 16B depict two examples of the sublinear phase derivative profiles in Cartesian (FIG. 16A) and polar (FIG. 16B) coordinate systems. More specifically, the phase derivate profile in the Cartesian coordinate system is given by the following.

PD(ωₓ,ω_{y})=Aₓ·tan⁻¹(Bₓ·ωₓ)+A_{y}·tan⁻¹(B_{y}·ω_{y}), (10)

with the phase derivate profile in polar coordinate system given by:

PD(ωᵣ,ω_{φ})=A·tan⁻¹(B·ωᵣ). (11)

AST can also be employed in an iterative algorithm to find the optimum filter phase profile (i.e., parameters A and B) that compresses the image modulation bandwidth while minimizing the number of samples required to represent the image. After the image is transformed using AST, its brightness bandwidth will be compressed with compression factor of M>1 where M can be an arbitrary positive number. Since the modulation spectrum of the transformed image is M times less than that of the original image, the transformed image can be down-sampled with factor M without losing any information. The resultant down-sampled image thus contains a significantly lower number of samples than the original image while containing all the information from the original image. The algorithm can also be utilized with adaptive quantization and entropy coding methods to further reduce image data size.

The AST operation can be implemented in digital domain or in analog optical domain. For the latter, the phase operation can be realized using a single or cascaded non-spherical lenses, spatial light modulators, diffractive gratings or diffractive mirrors. Specific optical elements include a warped/anamorphic lens, a non-spherical mirror in a reflective geometry, a non-spherical lens, such as two concatenated anamorphic lenses with one lens in the x-direction and one in the y-direction.

The operation can also be discretized along the propagation direction and be synthesized by a series of 2D thin films.

The compressed image data along with the parameters of the filter (A and B) and M factor may be transmitted through communication link or they may be saved in data storage. In reconstructing the original image from the compressed image, an interpolation is first performed with factor M and then the inverse AST (which is generated using A and B parameters) is utilized to reconstruct the original image.

It will be appreciated that the reshaping operation transforms the image such that coarse spatial features remain relatively unchanged but fine spatial features are stretched. This translates to higher resolution density for fine features in comparison to coarse features.

4. Outline of Equations Used in FSC Compression Method.

(a). Reshaping and complex amplitude recovery are performed in response to transforming the image brightness into functions, F1 and F2:

$$\{ \begin{matrix}F 1 ( {1}_{ij} ) = {\vert {B}_{i n} ( {1}_{ij} ) * K ( {1}_{ij} ) \vert}^{N} \\ and \\ F 2 ( {1}_{ij} ) = {\vert {B}_{i n} ( {1}_{ij} ) * K ( {1}_{ij} ) * M ( {1}_{ij} ) \vert}^{M}\end{matrix}$$

where 1ᵢⱼ represents a two dimensional spatial coordinate, Bᵢₙ (1ᵢⱼ) is the input image brightness, K(1₁ⱼ) is the kernel performing the reshaping, D(1ᵢⱼ) is the phase discriminator kernel, ∥ is the absolute operator, * is the convolution operator, N and M are integers with N≧1 and M≧1.

(b). The kernel K(1ᵢⱼ) is a phase operator, K(1ᵢⱼ)=e^{j·Φ(1}^{ᵢⱼ}⁾ where j=\sqrt{−1}. For space-bandwidth compression, the kernel phase derivative should have a superlinear profile, where phase derivative is

$$PD ( {1}_{ij} ) = \frac{d Φ ( {1}_{ij} )}{d {1}_{ij}} .$$

For space-bandwidth expansion, the phase derivative preferably has a sublinear profile.

(c). The integral form of above can be written as:

$$\{ \begin{matrix}F 1 ( {1}_{ij} ) = f ( \vert {\int }_{- ∞}^{∞} {e}^{jΦ ( {1}_{ij} - {1}_{ij}^{′} )} \cdot {B}_{i n} ( {1}_{ij}^{′} ) d {1}_{ij}^{′} \vert ) \\ F 2 ( {1}_{ij} ) = g ( \vert {\int }_{- ∞}^{∞} D ( {1}_{ij} - {1}_{ij}^{″} ) \cdot [ {\int }_{- ∞}^{∞} {e}^{jΦ ( {1}_{ij}^{″} - {1}_{ij}^{′} )} \cdot {B}_{i n} ( {1}_{ij}^{′} ) d {1}_{ij}^{′} ] d {1}_{ij}^{″} \vert )\end{matrix}$$

in which f and g are arbitrary injective or monotonic functions.

(d). For N=M=1, the integral form of above has been called generalized anamorphic stretch transform (g-AST), and can be written as:

$$\{ \begin{matrix}F 1 ( {1}_{ij} ) = \vert {\int }_{- ∞}^{∞} {e}^{jΦ ( {1}_{ij} - {1}_{ij}^{′} )} \cdot {B}_{i n} ( {1}_{ij}^{′} ) d {1}_{ij}^{′} \vert \\ F 2 ( {1}_{ij} ) = \vert {\int }_{- ∞}^{∞} D ( {1}_{ij} - {1}_{ij}^{″} ) \cdot [ {\int }_{- ∞}^{∞} {e}^{jΦ ( {1}_{ij}^{″} - {1}_{ij}^{′} )} \cdot {B}_{i n} ( {1}_{ij}^{′} ) d {1}_{ij}^{′} ] d {1}_{ij}^{″} \vert\end{matrix}$$

(e). For N=M=2, and in the frequency domain, the transformation has been called Anamorphic Stretch Transform (AST) or

Anamorphic Spectrum Transform, and can be written as:

$$\{ \begin{matrix}F 1 ( {ω}_{ij} ) = [ {\tilde{B}}_{i n} ( {ω}_{ij} ) \cdot \tilde{K} ( {ω}_{ij} ) ] ⊗ [ {\tilde{B}}_{i n} ( {ω}_{ij} ) \cdot \tilde{K} ( {ω}_{ij} ) ] \\ and \\ F 2 ( {ω}_{ij} ) = [ {\tilde{B}}_{i n} ( {ω}_{ij} ) \cdot \tilde{K} ( {ω}_{ij} ) \cdot \tilde{D} ( {ω}_{ij} ) ] ⊗ [ {\tilde{B}}_{i n} ( {ω}_{ij} ) \cdot \tilde{K} ( {ω}_{ij} ) \cdot \tilde{D} ( {ω}_{ij} ) ]\end{matrix}$$

where ωᵢⱼ represents two dimensional frequency variables, \tilde{B}ᵢₙ(ωᵢⱼ) is the input image spectrum, \tilde{K}(ωᵢⱼ) is a frequency domain reshaping kernel, \tilde{D}(ωᵢⱼ) is the frequency domain phase discriminator kernel, and [symbol] is the correlation operator.

(f). The frequency domain kernel \tilde{K}(ωᵢⱼ) is a phase operator, \tilde{K}(ωᵢⱼ)=e^{j·φ(ω}^{ᵢⱼ}⁾ where j=\sqrt{−1}.

(g). The frequency domain kernel phase derivative is

$$P \tilde{D} ( {ω}_{ij} ) = \frac{d ϕ ( {ω}_{ij} )}{d {ω}_{ij}} .$$

For space-bandwidth compression, a preferred phase derivative has a sublinear profile, such as but not limited to, an inverse tangent function. For space-bandwidth expansion, a superlinear profile is preferably utilized, such as but not limited to, the tangent function.

(h). In the frequency domain, the integral form of F1 and F2 are:

$$F 1 ( {ω}_{ij} ) = {\int }_{- ∞}^{∞} {\tilde{B}}_{i n} ( {ω}_{ij}^{′} ) \cdot {{\tilde{B}}_{i n}}^{*} ( {ω}_{ij}^{′} + {ω}_{ij} ) \cdot {e}^{j ( ϕ ( {ω}_{ij}^{′} ) - ϕ ( {ω}_{ij}^{′} + {ω}_{ij} ) )} d {ω}_{ij}^{′}$$

$$F 2 ( {ω}_{ij} ) = {\int }_{- ∞}^{∞} {\tilde{B}}_{i n} ( {ω}_{ij}^{′} ) \cdot {{\tilde{B}}_{i n}}^{*} ( {ω}_{ij}^{′} + {ω}_{ij} ) \cdot \tilde{D} ( {ω}_{ij}^{′} ) \cdot {\tilde{D}}^{*} ( {ω}_{ij}^{′} + {ω}_{ij} ) \cdot {e}^{j ( ϕ ( {ω}_{ij}^{′} ) - ϕ ( {ω}_{ij}^{′} + {ω}_{ij} ) )} d {ω}_{ij}^{′}$$

(i). Decompression requires knowledge of the complex amplitude of the reshaped image. Complex amplitude is obtained from the recovered F1 and F2 using a phase recovery algorithm.

(j). The transform can be represented in the discrete domain as follows:

$${B}_{i n} [ n , m ] = \{ \begin{matrix}{F}_{1} [ n , m ] = {\vert {\sum }_{{k}_{1} , {k}_{2} = - ∞}^{∞} K [ n - {k}_{1} , m - {k}_{2} ] \cdot {B}_{i n} [ {k}_{1} , {k}_{2} ] \vert}^{N} \\ {F}_{2} [ n , m ] = {\vert {\sum }_{{k}_{1} , {k}_{2} , {k}_{3} , {k}_{4} = - ∞}^{∞} D [ n - {k}_{3} , m - {k}_{4} ] \cdot K [ {k}_{3} - {k}_{1} , {k}_{4} - {k}_{2} ] \cdot {B}_{i n} [ {k}_{1} , {k}_{2} ] \vert}^{M}\end{matrix}$$

where n and m represent two dimensional spatial coordinate indices, Bᵢₙ [n,m] is the input image brightness, K[n,m] is the kernel performing the reshaping, D[n,m] is the Phase Discriminator kernel, ∥ is the absolute operator, and f[n,m] and g[n,m] are injective or monotonic functions for n,m≧0.

(k). The Kernel K[n,m] is a phase operator K[n,m]=e^{j·φ[n,m]}, where j=\sqrt{−1}. For space-bandwidth compression, the kernel phase derivative preferably has a superlinear profile, where phase derivative is PD[n,m]=K[n,m]−K[n−1,m−1]. For space-bandwidth expansion, the phase derivative should have a sublinear profile.

(l). D[n,m] is a 2D kernel responsible for complex-field recovery.

(m). For N=M=1 and in the discrete space domain, the transform can be written as:

$$\{ \begin{matrix}{F}_{1} [ n , m ] = \vert {\sum }_{{k}_{1} , {k}_{2} = - ∞}^{∞} K [ n - {k}_{1} , m - {k}_{2} ] \cdot {B}_{i n} [ {k}_{1} , {k}_{2} ] \vert \\ {F}_{2} [ n , m ] = \vert {\sum }_{{k}_{1} , {k}_{2} , {k}_{3} , {k}_{4} = - ∞}^{∞} D [ n - {k}_{3} , m - {k}_{4} ] \cdot K [ {k}_{3} - {k}_{1} , {k}_{4} - {k}_{2} ] \cdot {B}_{i n} [ {k}_{1} , {k}_{2} ] \vert\end{matrix}$$

(n). For N=M=2 and in the frequency domain, the discretized transform can be written as:

$$\{ \begin{matrix}{\tilde{F}}_{1} [ n , m ] = {\sum }_{{k}_{1} , {k}_{2} = - ∞}^{∞} {\tilde{B}}_{i n} [ {k}_{1} , {k}_{2} ] \cdot {{\tilde{B}}_{i n}}^{*} [ n + {k}_{1} , m + {k}_{2} ] \cdot \tilde{K} [ {k}_{1} , {k}_{2} ] \cdot \\ {\tilde{K}}^{*} [ n + {k}_{1} , m + {k}_{2} ] \\ {\tilde{F}}_{2} [ n , m ] = {\sum }_{{k}_{1} , {k}_{2} = - ∞}^{∞} {\tilde{B}}_{i n} [ {k}_{1} , {k}_{2} ] \cdot {{\tilde{B}}_{i n}}^{*} [ n + {k}_{1} , m + {k}_{2} ] \cdot \tilde{K} [ {k}_{1} , {k}_{2} ] \cdot \\ {\tilde{K}}^{*} [ n + {k}_{1} , m + {k}_{2} ] \cdot \tilde{D} [ {k}_{1} , {k}_{2} ] \cdot {\tilde{D}}^{*} [ n + {k}_{1} , m + {k}_{2} ]\end{matrix}$$

5. Embodiments of FSC with Secondary Compression.

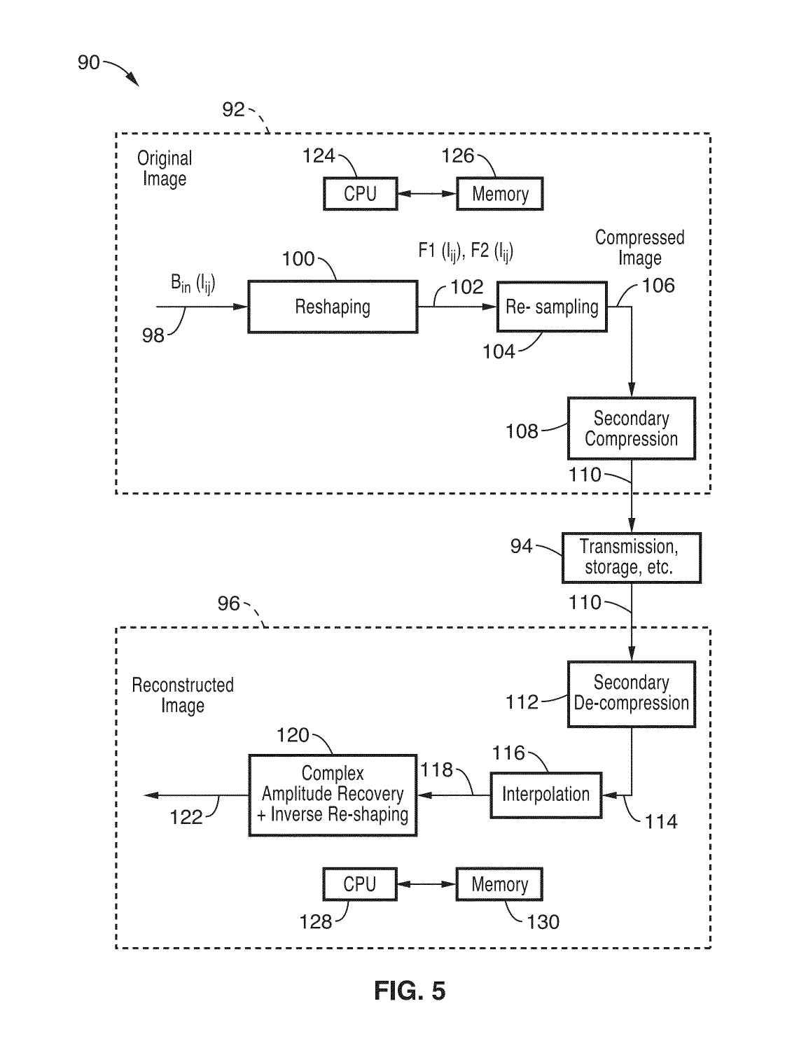

FIG. 5 illustrates an example embodiment 90 of inventive FSC compression 92, transmission or storage 94, and inventive FSC decompression 96. An original image 98 Bᵢₙ(1ᵢⱼ) is received upon which reshaping 100 is performed to output an image F1(1ᵢⱼ); F2(1ᵢⱼ) 102, which is re-sampling 104 to output a compressed image 106, which is input to a secondary compression method 108 and output 110 for transmission or storage 94. Secondary compression may comprise any desired method, or combination of methods, including but not limited to JPEG, WebP. Alternatively, or additionally, down-sampling 104 may comprise a compressive sampling method.

To playback the image (still or video images), FSC compressed image data is received from a transmission link or data storage 94 and a secondary decompression 112 is performed to output image 114 for interpolation 116 and output an intermediate image signal 118 for complex amplitude recovery and inverse reshaping 120 to output reconstructed image 122.

By way of example and not limitation, computational elements are shown in the compressor and decompressor sections, such as comprising one or more computer or processing elements (CPU) 124, 128, and associated memory 126, 130 for performing programming for executing the described compression and decompression steps. It will be appreciated that other forms of digital circuitry and analog elements may be utilized without departing from the teachings of the present invention.

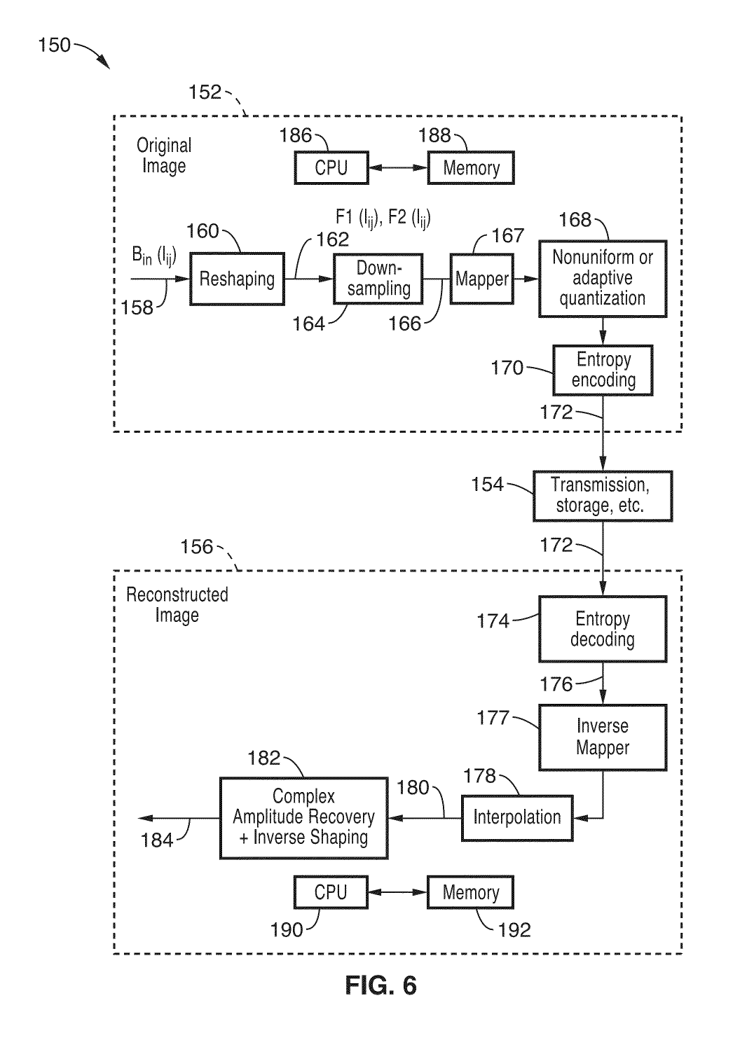

FIG. 6 illustrates an example embodiment 150 of inventive FSC compression utilized in combination with quantization and entropy encoding. An inventive FSC compressor 152 is seen outputting a compressed image for transmission or storage 154, and inventive FSC decompression 156.

An original image 158 Bᵢₙ(1ᵢⱼ) is received upon which reshaping 160 is performed to output an image F1(1ᵢⱼ); F2(1ᵢⱼ) 162, which is re-sampled (e.g., down-sampled) 164 to output a compressed image 166, which is input secondary video compression shown as a mapper 167, followed by nonuniform or adaptive quantization 168 followed by entropy encoding 170 to output compressed image 172 for transmission or storage 154. It should be appreciated that nonuniform and adaptive quantization, as well as entropy encoding, are well known in the art, whereas detailed descriptions of these techniques are not necessary herein. Playback comprises entropy decoding 174 to output image 176 to an inverse mapper 177, followed by interpolation 178 to output intermediate image 180 to which complex amplitude recovery and inverse reshaping 182 is performed to output reconstructed image 184.

Computational elements are seen as computer 186, 190, and memory 188, 192 for performing programming to execute the described compression and decompression steps. It should also be appreciated that other forms of digital circuitry and even analog elements may be utilized without departing from the teachings of the present invention.

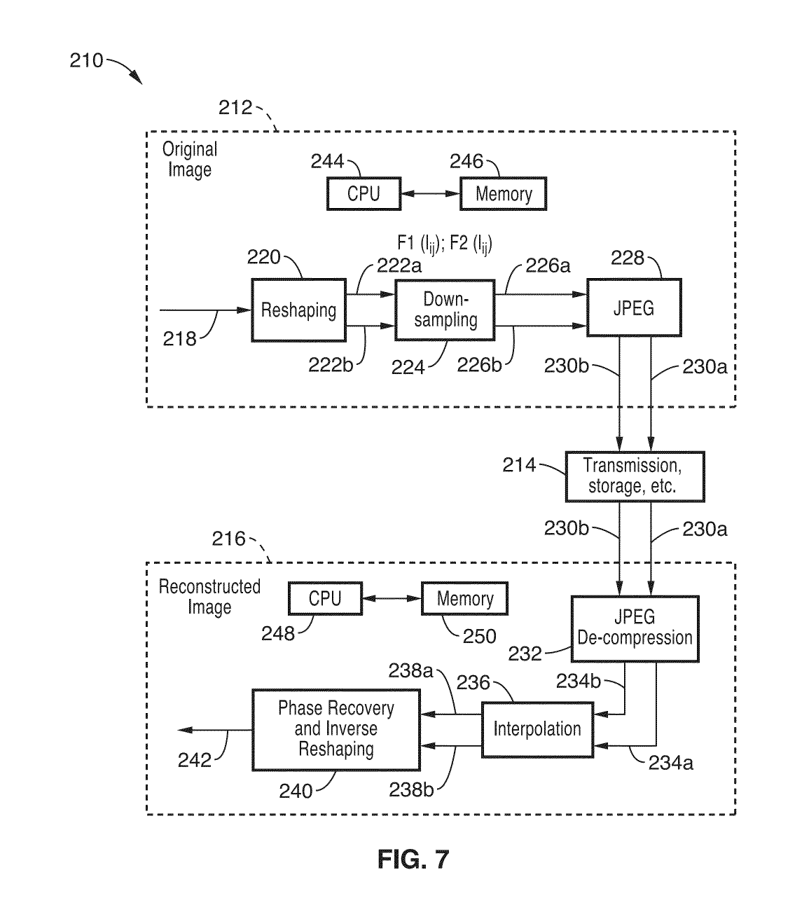

FIG. 7 illustrates an example embodiment 210 of inventive FSC compression in combination with JPEG compression. An inventive FSC compressor 212 is seen outputting a compressed image for transmission or storage 214, and inventive FSC decompression 216. An original image 218 Bᵢₙ(1ᵢⱼ) is received upon which reshaping 220 is performed to output transformed brightness F1(1ᵢⱼ); F2(1ᵢⱼ) 222a, 222b, which is down-sampled 224 to output a compressed image 226a, 226b, which is input for JPEG compression 228 outputting compressed image 230a, 230b for transmission or storage 214. It should be appreciated that JPEG compression and decompression, is well known in the art, whereby a detailed description is not necessary. Playback comprises JPEG decompression 232 to output image 234a, 234b, for interpolation 236 to output intermediate image 238a, 238b, to which phase recovery and inverse reshaping 240 is performed to output reconstructed image 242.

Computational elements are seen as computer 244, 248, and memory 246, 250 for performing programming to execute the described compression and decompression steps. As mentioned previously, it should also be appreciated that other forms of digital circuitry and even analog elements may be utilized without departing from the teachings of the present invention.

One embodiment of the above was implemented with the different blocks implemented using MATLAB. To generate the function F1, reshaping was applied to the input image in the frequency domain and then converted back to the spatial domain. To generate function F2, reshaping cascaded with phase discrimination was applied to the input image in the frequency domain and was converted back to the spatial domain. Absolute values (brightness) of the functions F1 and F2 were calculated, down-sampled and stored using standard JPEG. For image decompression, two stored JPEG images were decoded using JPEG decoder. The resulting 2D array was then up-sampled. The two brightnesses, F1 and F2, were then used in the phase recovery algorithm. The input image was then recovered using inverse reshaping. The phase recovery algorithm in these specific examples was based on two dimensional implementation of Stereopsis-Inspired Time-Stretched Amplified Real-Time Spectrometer (STARS).

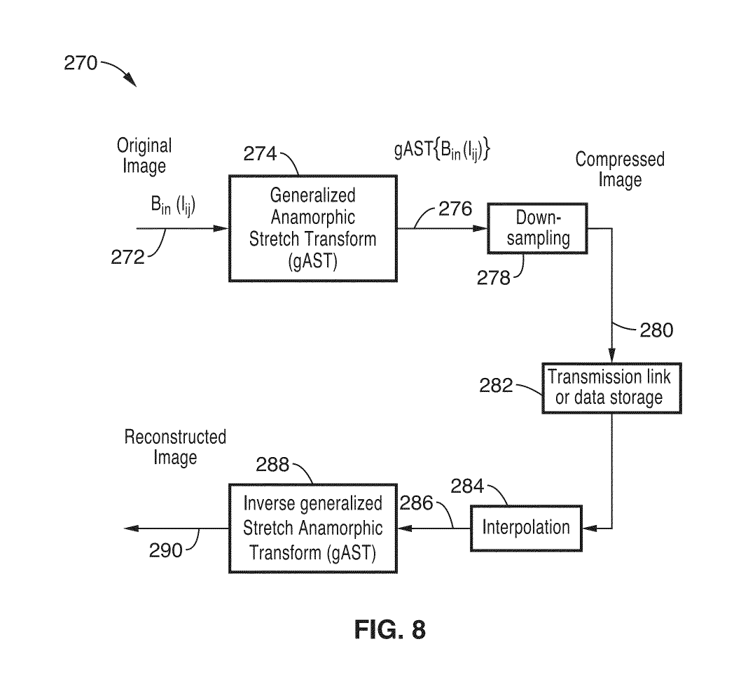

FIG. 8 illustrates an example embodiment 270 of inventive FSC compression utilizing a generalized anamorphic stretch transform (gAST). An original image 272 Bᵢₙ (1ᵢⱼ) is received upon which a generalized anamorphic transform 274 is applied to output gAST{Bᵢₙ(1ᵢⱼ)} 276 that is down-sampled 278 to output a compressed image 280 for transmission or storage 282. During playback of the compressed data, interpolation 284 is performed to output intermediate image 286 upon which an inverse generalized anamorphic stretch transform is applied (inverse-gAST) 288 to output reconstructed image 290. For the sake of simplicity of illustration, computational elements are not shown, but may utilize the same processing elements for executing programming as described in previous embodiments above.

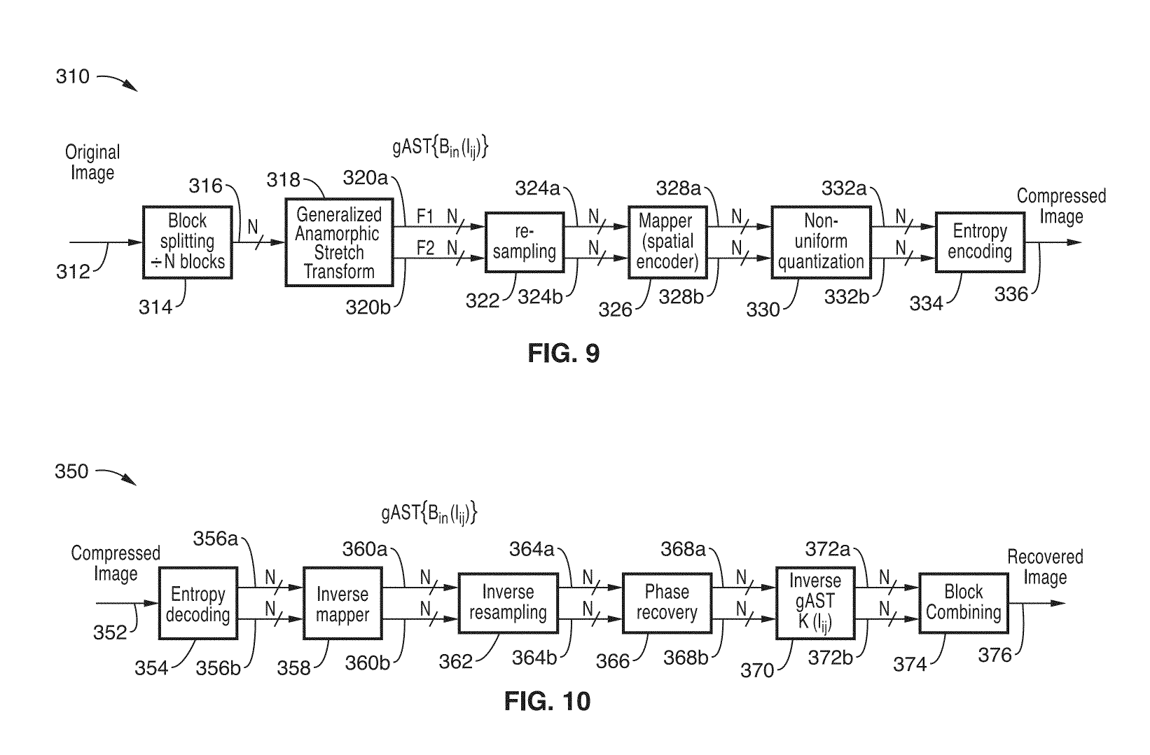

FIG. 9 illustrates an example embodiment 310 of anamorphic image compression, utilizing the generalized anamorphic stretch transform (gAST) of the invention. In at least one preferred embodiment, the image compression is performed in the digital domain, such as executing depicted method steps by programming on one or more associated computer processors and memory, which are not shown in this figure for the sake of simplicity of illustration. It should also be appreciated, as mentioned previously, that other forms of digital circuitry and even analog elements may be utilized without departing from the teachings of the present invention.

In FIG. 9, an original image is received 312, and subject to block splitting 314 to N blocks, which are output 316 for generalized anamorphic stretch transform (gAST) 318 which outputs blocks F1 320a, and F2 320b for resampling 322 output as 324a, 324b, to a mapper (e.g., spatial encoder) 326 outputting encoded blocks 328a, 328b for non-uniform quantization 330, whose quantized blocks 332a, 332b, are received for entropy encoding 334 and output as compressed image 336.

The object in the gAST compression system is to compress the space-bandwidth product of a digital two dimensional spatial image (frame) brightness. In this method the digital image passes through a mathematical transform, exemplified here as gAST, as follows:

$$gAST \{ {B}_{i n} ( {1}_{ij} ) \} ( {1}_{ij} ) ⇒ \{ \begin{matrix}F 1 ( {1}_{ij} ) = f ( \vert {\int }_{- ∞}^{∞} {e}^{jΦ ( {1}_{ij} - {1}_{ij}^{′} )} \cdot {B}_{i n} ( {1}_{ij}^{′} ) d {1}_{ij}^{′} \vert ) \\ F 2 ( {1}_{ij} ) = g ( \vert {\int }_{- ∞}^{∞} D ( {1}_{ij} - {1}_{ij}^{″} ) \cdot [ {\int }_{- ∞}^{∞} {e}^{jΦ ( {1}_{ij}^{″} - {1}_{ij}^{′} )} \cdot {B}_{i n} ( {1}_{ij}^{′} ) d {1}_{ij}^{′} ] d {1}_{ij}^{″} \vert )\end{matrix}$$

The gAST warps the spatial image by convolution with a two dimensional kernel and creates two spatial parameters, F1 and F2, which are functions of transformed image brightness. It has been found herein that utilizing a special gAST kernel, preferably with a superlinear local frequency profile (tan( )), that the spatial bandwidth of F1 and F2 are much smaller than the original image. This arises because spatial coherency is increased after the gAST operation. Since the bandwidth of F1 and F2 are smaller than the original image, they can be down-sampled without losing any information. The mapper (spatial encoder) can comprise, for example, a run-length encoder. The use of nonuniform quantization de-emphasizes the resolution based on psycho-visual considerations. Entropy encoding uses coding to achieve further compression. For color images, the algorithm incorporates a multi-color redundancy encoder. Block splitting can be also used for large images for better computing efficiency or to benefit from parallel computing schemes.

FIG. 10 illustrates an example embodiment 350 of anamorphic image decompression, utilizing the inverse generalized anamorphic stretch transform (inverse-gAST) of the invention from the output seen in FIG. 9. The image decompression is also preferably performed in the digital domain, such as executing depicted method steps by programming on one or more associated computer processors and memory, which are not shown in this figure for the sake of simplicity of illustration.

In FIG. 10, a compressed image 352 is received for entropy decoding 354 to output blocks 356a, 356b, to an inverse mapper 358, whose mapped output 360a, 360b, are received for inverse sampling 362. Phase recovery 366 is then performed on block output 364a, 364b from inverse sampling. An inverse-gAST, K(1ᵢⱼ)⁻¹ 370, is performed on phase recovery outputs 368a, 368b. Blocks 372a, 372b from inverse-gAST are then recombined 374 into a recovered image 376.

It should be appreciated that gAST can be equivalently performed in the analog domain, or more preferably a combination of analog and digital domains. By way of example and not limitation, this can be achieved by slightly altering the steps seen in FIG. 9 as follows. The block splitting is not initially performed, whereas gAST and resampling (e.g., under-sampling, such as on an image sensor) are performed in the analog domain. After resampling, then block splitting is performed followed by mapping, non-uniform quantization and entropy encoding.

Utilizing analog gAST processing can decrease the burden on the digital processing with the optical image first passing through the analog implementation of gAST. The image space-bandwidth product is compressed so an image sensor with smaller number of pixels can be used to capture the image that otherwise would need much higher number of pixels. The digital backend electronics performs optional block splitting, mapper (spatial encoder), non-uniform quantization and entropy encoding. For color images, spatial color filtering in the analog side is preferably utilized and a color redundancy encoder is also utilized on the digital processing side. Digital processing can be performed in response to programming executing on a computer, or performed in digital hardware utilizing FPGA, GPU and so forth, which applies equally to all inventive embodiments described.

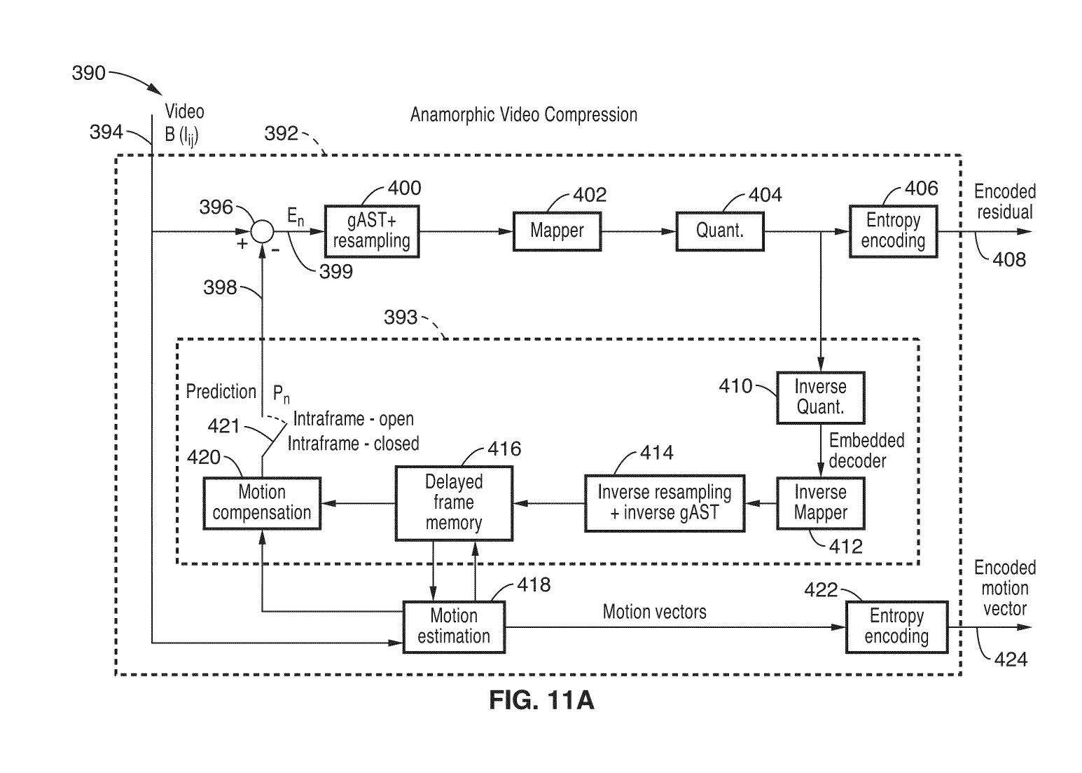

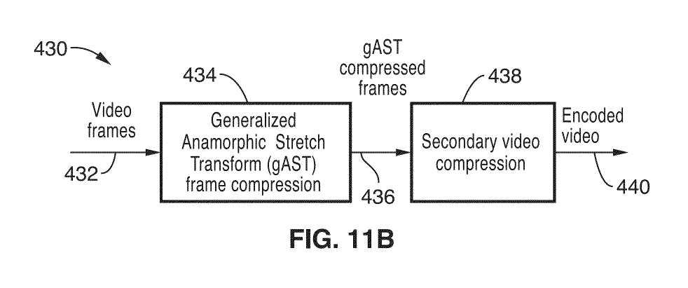

FIG. 11A and FIG. 11B illustrate example embodiments 390, 430 of the present invention utilized in video compression. FIG. 11A illustrates an example embodiment 390 of anamorphic video compression. In addition to the execution blocks described in FIG. 9 and FIG. 10, the video data compressor also reduces redundancy in the time dimension to further compress the video data size. An embedded frame decoder and motion estimator block are preferably utilized to find motion vectors of the frames and send the encoded residual information along with the encoded motion vectors to the communication channel or storage.

More specifically, in FIG. 11A, a video 394 is received by an encoder 392 with a difference taken at summing element 396 with encoded-decoded image data 398 to produce a residual 399 to be compressed and encoded for use along with the motion information (e.g., motion vectors). Residual block information is received for gAST and resampling at block 400 followed by mapping (e.g., transforms) 402, and quantization 404. The quantized encoded residual is then entropy encoded 406 and output as an encoded residual 408. Within the encoder a decoder section 393 receives transform-quantized block data upon which inverse quantization 410 and inverse mapping (e.g., inverse transforms) 412 are performed, followed by inverse resampling and inverse-gAST 414 received in delayed frame memory 416. Motion estimation (ME) is performed 418 based on the delayed frame memory while motion compensation (MC) is performed 420 selectively 421 for intra-frame and inter-frames. Motion vectors are entropy encoded 422 for output 424 as encoded motion vectors. It should be appreciated that a decoder would be implemented largely as described in block 393 above.

It should also be appreciated that the encoder 390 is preferably implemented using a processing means, such as comprising at least one processing device (e.g., computer, CPU, DSP, ASIC with CPU), separately or in combination with logic arrays and other digital logic as desired. In addition, it will be appreciated that elements of the present invention can be implemented as programming stored on a media, which can be accessed for execution by a CPU for the encoder and/or decoder.

In FIG. 11B an example embodiment 430 is shown of using feature selective compression in a general video encoding embodiment to enhance the compression factor and/or video quality. Video frames 432 are received for frame compression utilizing the generalized anamorphic stretch transform 434, the output of which are gAST compressed frames 436 received for secondary video compression 438, having compressed encoded output 440. Video frame decoding would follow the reverse of that shown in FIG. 11B, with secondary video decompression, followed by frame decompression utilizing inverse generalized anamorphic stretch transform (inverse gAST) being executed.

For the sake of simplicity of illustration, the above embodiments were described as directed to monochrome images (i.e., brightness channel only). However, it should be appreciated that the present invention operates equally well with color images, as feature selective compression (FSC) is applied to each color component of the image. In addition, one of ordinary skill in the art will appreciate that FSC is applicable to 3D imaging, which is typically rendered with pairs of images/video streams. FSC compression, in its various forms as described, is also applicable to digital video and streaming-image compression by efficient compression of each video frame prior to video compression or integrated in the whole process of video compression.

More particularly, color capability can be achieved by applying FSC to each color component separately (e.g., RBG or Y′C_{B}C_{R}). Video is considered as three dimensional data consisting of two dimensional spatial information and one dimensional time information (consecutive video frames). Video compression methods usually have a block to reduce the spatial data redundancy and a block for reducing the temporal redundancy (e.g. by using movement vectors).

6. Numerical Results.

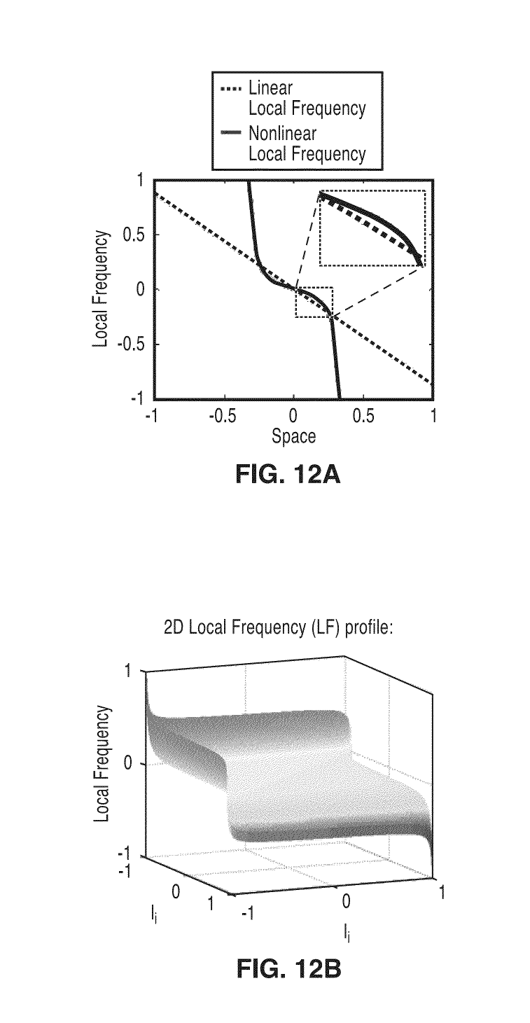

FIG. 12A and FIG. 12B illustrate 1D and 2D local frequency profiles utilizing the anamorphic stretch transform (AST). In FIG. 12A is seen a local frequency profile in 1D for an anamorphic stretch transform (AST) tested for a 1 Mega pixel raw image. In FIG. 12B is seen a local frequency profile in 2D for the AST.

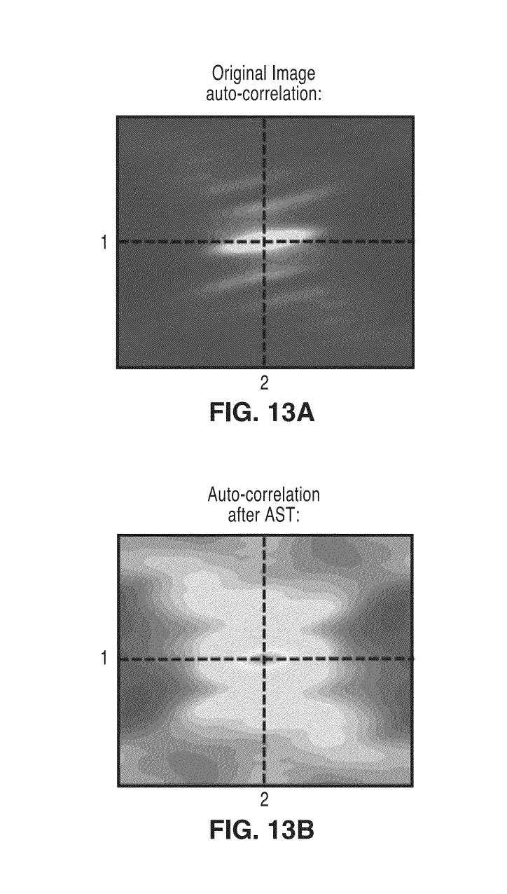

FIG. 13A and FIG. 13B compare autocorrelations of the original image with the transformed one, as an aid to understanding how the space-bandwidth product is compressed. FIG. 13A depicts auto-correlation before AST with FIG. 13B depicting it after AST. As it can be seen in comparing these two graphs, autocorrelation is substantially broadened after AST.

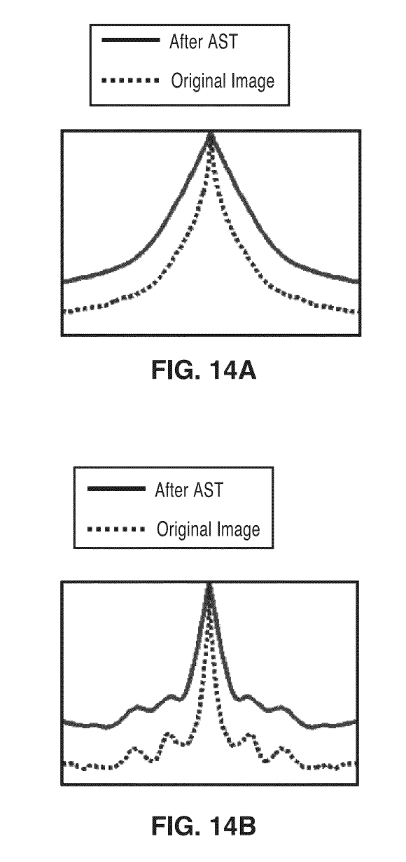

FIG. 14A and FIG. 14B illustrate vividly the increase in horizontal (FIG. 14A) and vertical (FIG. 14B) 1D autocorrelation. Each graph showing autocorrelation in the original image as a dotted line, with a solid line showing autocorrelation after AST. The broader autocorrelation indicates increased coherency which translates into fewer bits needed to represent the image.

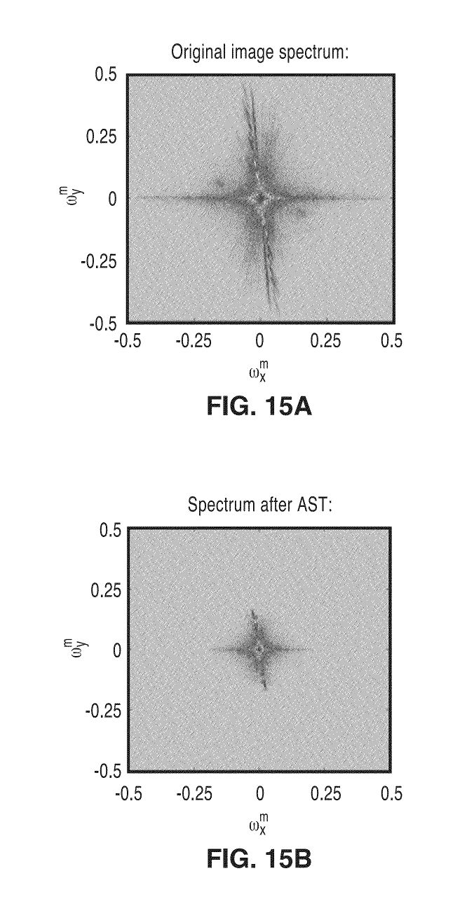

FIG. 15A and FIG. 15B illustrate a comparison of spatial bandwidth before and after AST. It will be appreciated that because of the changes in spectrum, the AST operation is also referred to as an anamorphic spectral transform (AST), as well as an anamorphic stretch transform (AST). It is readily seen that the spatial bandwidth after AST in FIG. 15B is significantly less than the original spectrum in FIG. 15A. It will be noted, however, that the spatial size of the image is not increased, whereby AST clearly reduces space-bandwidth product.

FIG. 16A and FIG. 16B are graphs of sublinear phase derivative profiles utilized to perform an anamorphic stretch transform (AST) according to the present invention, for the Cartesian (FIG. 16A), and polar coordinate systems (FIG. 16B). It can be seen in FIG. 16A that the frequency response resembles the letter “S”, whereby the operation has also been referred to as the s-transform (ST). One example of an S-shaped function is the inverse tangent function.

A number of tests were performed comparing the performance of image compression using conventional down-sampling/low-pass filtering with the proposed image compression using AST. It was found that the AST compressed images had superior resolution although having the same number of pixels. The following are image comparisons in which image quality benefits of the inventive compression are readily seen.

7. Visual Results.

It has been described in detail in preceding sections that the present invention can be utilized as a pre-compression method in conjunction with other available compression methods to yield improved performance. As can be seen from the following, the benefits of the present invention can be seen visually in the image results, even making text elements clearly legible which were illegible without the inventive pre-compression. Thus, it is apparent that images using FSC pre-compression provide significantly higher resolutions despite having the same file sizes.

FIG. 17A and FIG. 17B depict an original image and a stretch transformed image of a double-decker bus. The example image was captured as a 1 Mega pixel raw image seen in FIG. 17A, which was transformed utilizing the phase derivative profile of FIG. 12A and FIG. 12B. FIG. 17B depicts the image of the double-decker bus after transformation. To understand how the space-bandwidth product is compressed, FIG. 13A and FIG. 13B compared autocorrelations of the original image with the transformed one. As it can be seen, the autocorrelation is broadened. The broadening of the horizontal and vertical 1D autocorrelation line scans was vividly depicted in FIG. 14A and FIG. 14B. The broader autocorrelation indicates increased coherency which translates into fewer bits required for representing the image. FIG. 15A and FIG. 15B depicted the reduction in spatial bandwidth, while as seen in the transformed image of FIG. 17B the spatial size of the image is almost unchanged, whereby it is clear that the space-bandwidth product is reduced.

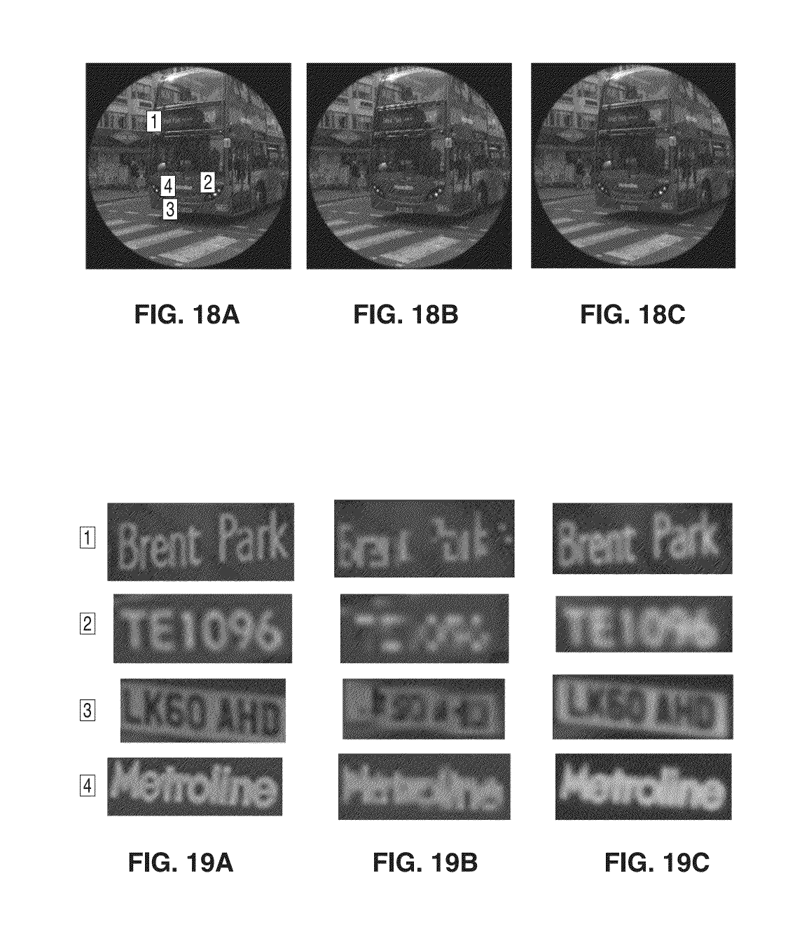

FIG. 18A through FIG. 18C are an original image of a double-decker bus in FIG. 18A, with comparison images after conventional down-sampled compression FIG. 18B, and feature selective compression in FIG. 18C.

FIG. 19A through FIG. 19C compares four textual elements (1-4) found in each of the images being compared in FIG. 18A through 18C for the original image, down-sampled image, and inventive feature selective compression. It is readily seen in these magnified images that the inventive compression although utilizing a number of bits equivalent to conventional down-sampled compression, provides an image quality which is far closer to the original, allowing all these text characters to be read in the FSC compression.

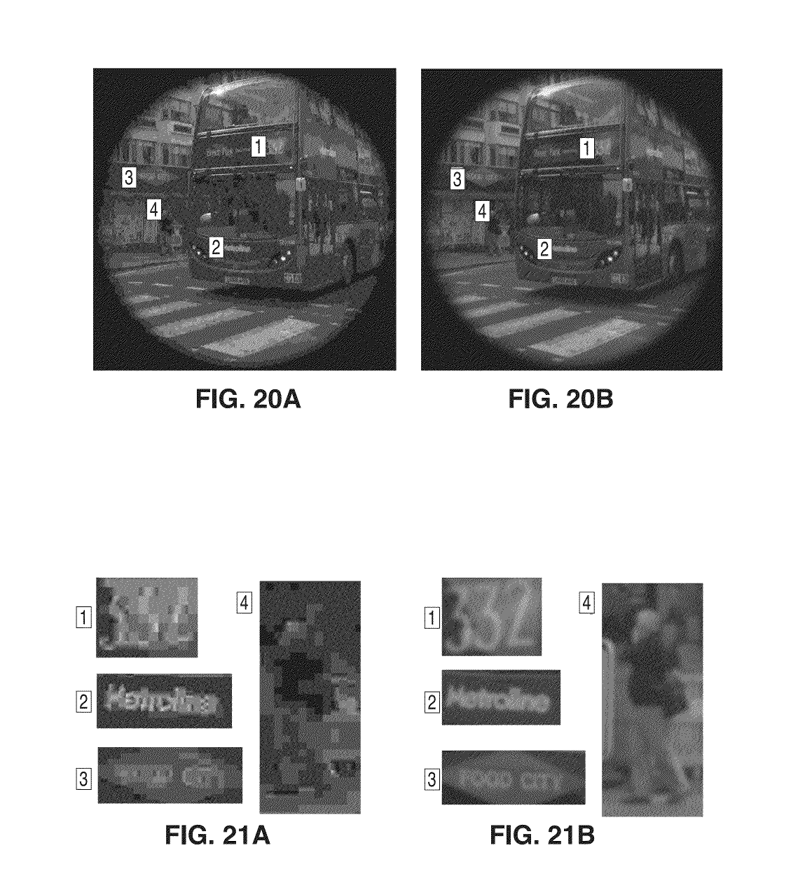

FIG. 20A and FIG. 20B compare images of the double-decker bus resulting from JPEG compression in FIG. 20A, and feature selective compression in combination with JPEG compression in FIG. 20B. FIG. 20A shows the image compressed using standard JPEG format with a compression factor of 56, in which the resultant compressed image data size was 55 kB. FIG. 20B shows the image pre-compressed by the inventive FSC method, before JPEG compression, with the result also having a compressed image data size of 55 kB, the same as that of the JPEG image. As clearly evidenced from the images, pre-compressed the inventive FSC method provide substantially higher resolution for the same image data size. This image quality comparison is more discernable in images 1-4 seen in each of FIG. 21A and FIG. 21B.

FIG. 21A and FIG. 21B magnify elements (textual and non-textual) found in the images of FIG. 20A and FIG. 20B for JPEG compression, and FSC pre-compression of JPEG. The clarity and readability differences between these images is readily apparent.

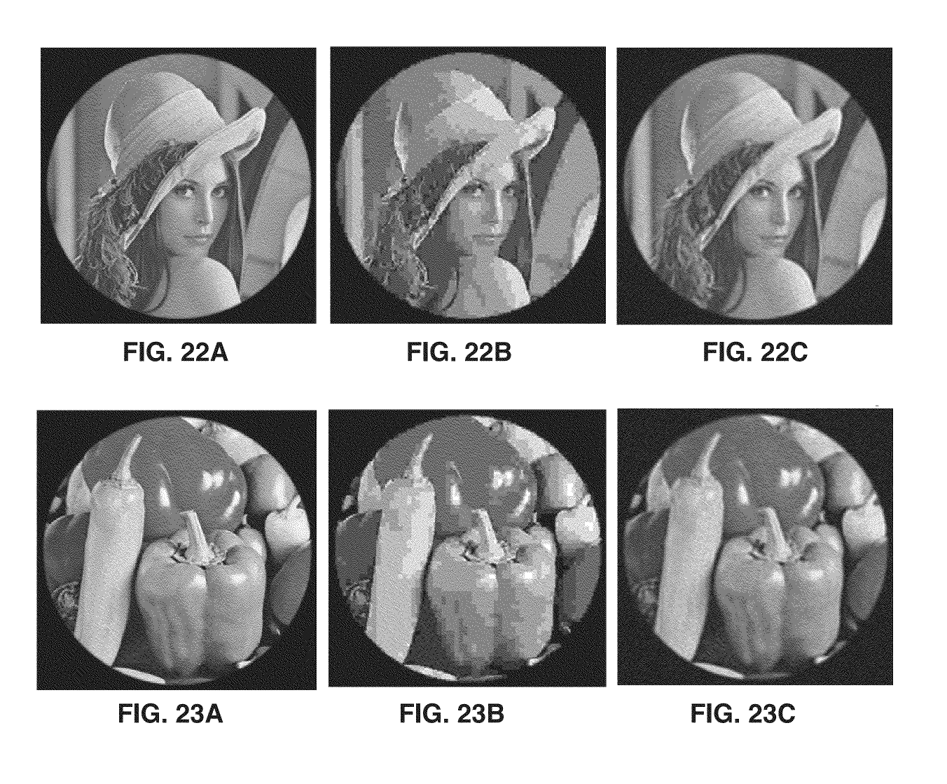

FIG. 22A through FIG. 22C are images of an actress which compare an original image in FIG. 22A, with a JPEG compressed image in FIG. 22B, and a feature selective compression utilized in combination with JPEG in FIG. 22C. The images are gray-scale images with the original having 512×512 pixels and an original data size of 256 kB in TIF format. FIG. 22B shows the image after standard JPEG compression with compression factor of 56 to a data size of 4.5 kB. FIG. 22C depicts the image after FSC pre-compression before JPEG while maintaining the same total compression factor of 56. Again, one can readily see significant visual improvement of the images.

FIG. 23A through FIG. 23C are images of a group of peppers comparing an original image in FIG. 23A, JPEG compressed image in FIG. 23B, and feature selective compression utilized with JPEG in FIG. 23C. The original image and compression in FIG. 23A through FIG. 23C are the same as for the previous example images of FIG. 22A through FIG. 22C.

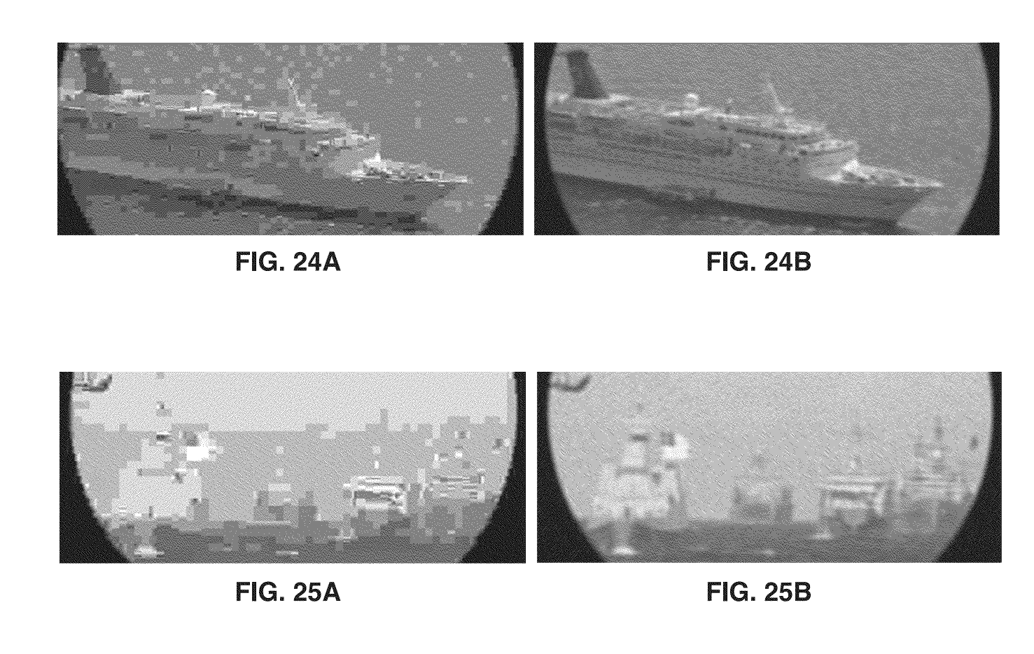

FIG. 24A through FIG. 34B provide visual comparisons of the inventive FSC pre-compression+JPEG with standard JPEG for applications in a number of example application areas, comprising naval surveillance, satellite imaging, night vision imaging, facial recognition and medical imaging. In each of these image comparisons a compression factor of 56 is utilized, by way of example and not limitation (in practice any desired compression factor can be selected). The following images clearly show superior performance of the FSC+JPEG over traditional JPEG, although utilizing the same compression factor and final file size. It is important to appreciate that these results were not obtained by a mere improvement in JPEG, but were achieved utilizing a qualitatively different approach to data compression.

FIG. 24A and FIG. 24B are naval surveillance images of an ocean liner comparing a JPEG compressed image in FIG. 24A, with FSC pre-compressed JPEG in FIG. 24B.

FIG. 25A and FIG. 25B are naval surveillance images of a ship convoy comparing a JPEG compressed image in FIG. 25A, with an FSC pre-compressed JPEG image in FIG. 25B.

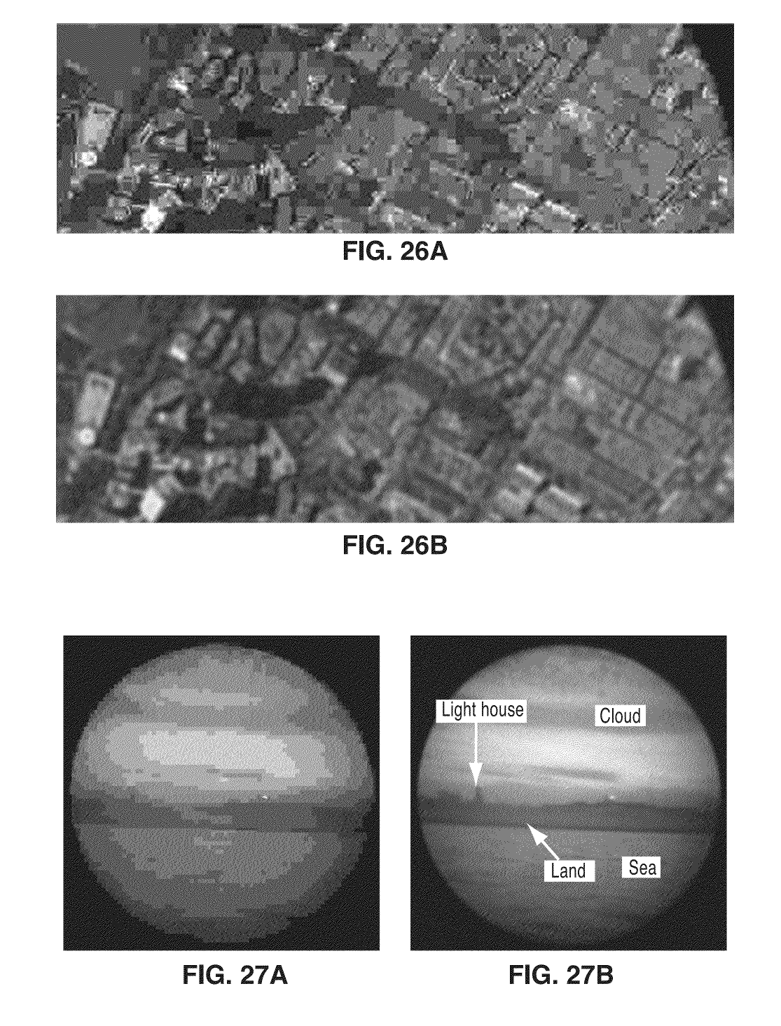

FIG. 26A and FIG. 26B are satellite imaging of an aerial city view comparing a JPEG compressed image in FIG. 26A, with an FSC pre-compressed JPEG image in FIG. 26B.

FIG. 27A and FIG. 27B are night vision images of a shoreline comparing a JPEG compressed image in FIG. 27A, with an FSC pre-compressed JPEG image in FIG. 27B.

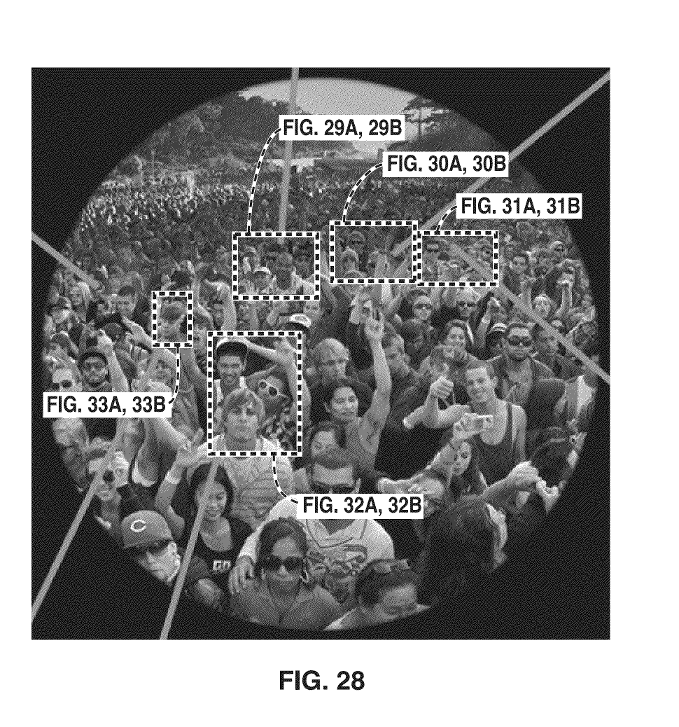

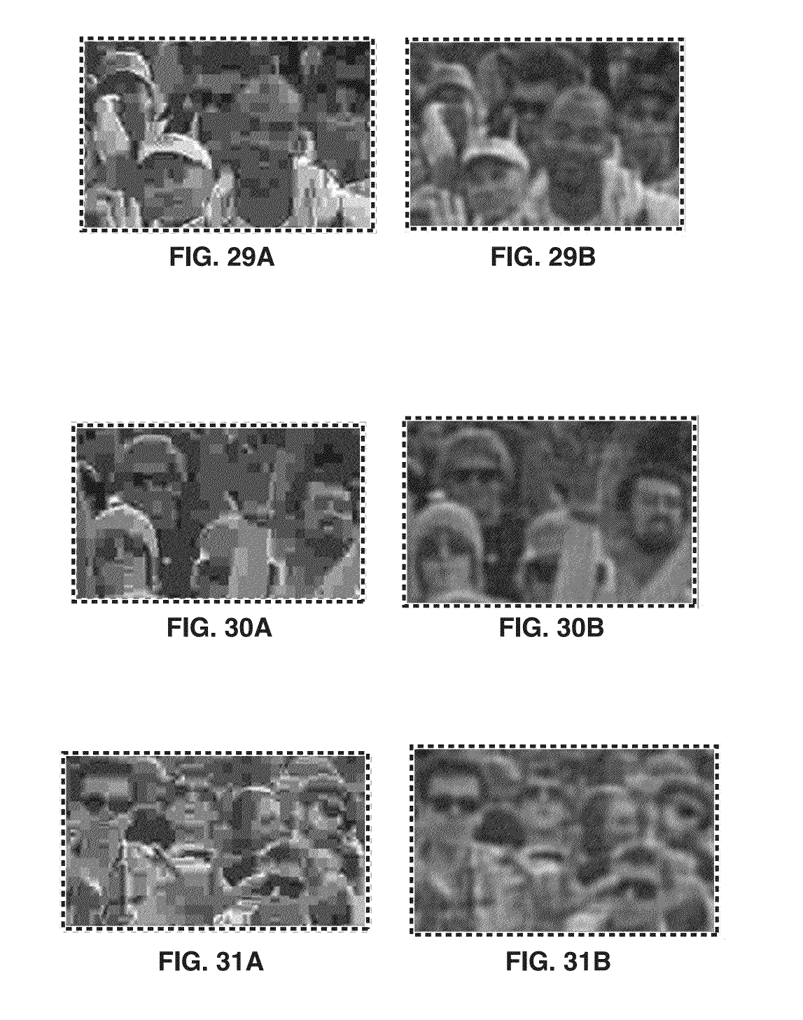

FIG. 28 is an original image of a large crowd of people, such as utilized for performing facial recognition. This image is utilized in FIG. 29A through FIG. 34B for comparing JPEG compression, to FSC pre-compression followed by JPEG compression, as detailed in FIG. 29A through FIG. 34B.

FIG. 29A and FIG. 29B are an image comparison of JPEG compression in FIG. 29A, with FSC+JPEG in FIG. 29B, from a section of the original image seen in FIG. 28.

FIG. 30A and FIG. 30B are an image comparison of JPEG compression in FIG. 30A, with FSC+JPEG in FIG. 30, from a section of the original image seen in FIG. 28.

FIG. 31A and FIG. 31B are an image comparison of JPEG compression in FIG. 31A, with FSC+JPEG in FIG. 31B, from a section of the original image seen in FIG. 28.

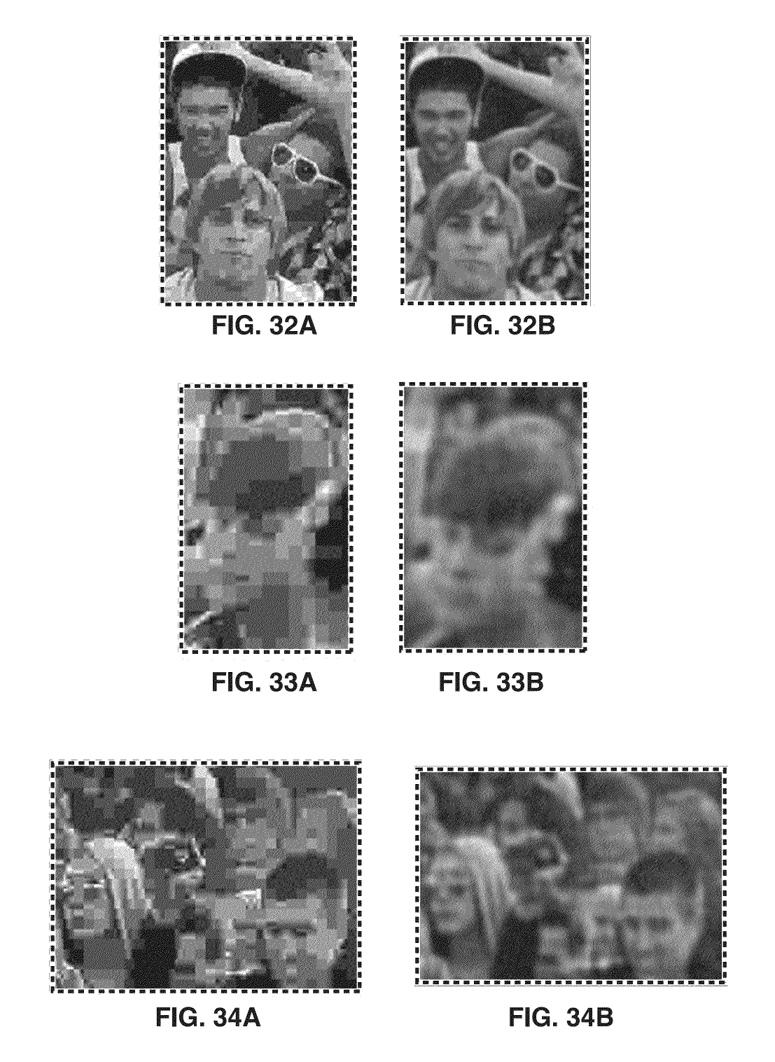

FIG. 32A and FIG. 32B are an image comparison of JPEG compression in FIG. 32A, with FSC+JPEG in FIG. 32B, from a section of the original image seen in FIG. 28.

FIG. 33A and FIG. 33B are an image comparison of JPEG compression in FIG. 33A, with FSC+JPEG in FIG. 33B, from a section of the original image seen in FIG. 28.

FIG. 34A and FIG. 34B are an image comparison of JPEG compression in FIG. 34A, with FSC+JPEG in FIG. 34B, from a section of the original image seen in FIG. 28.

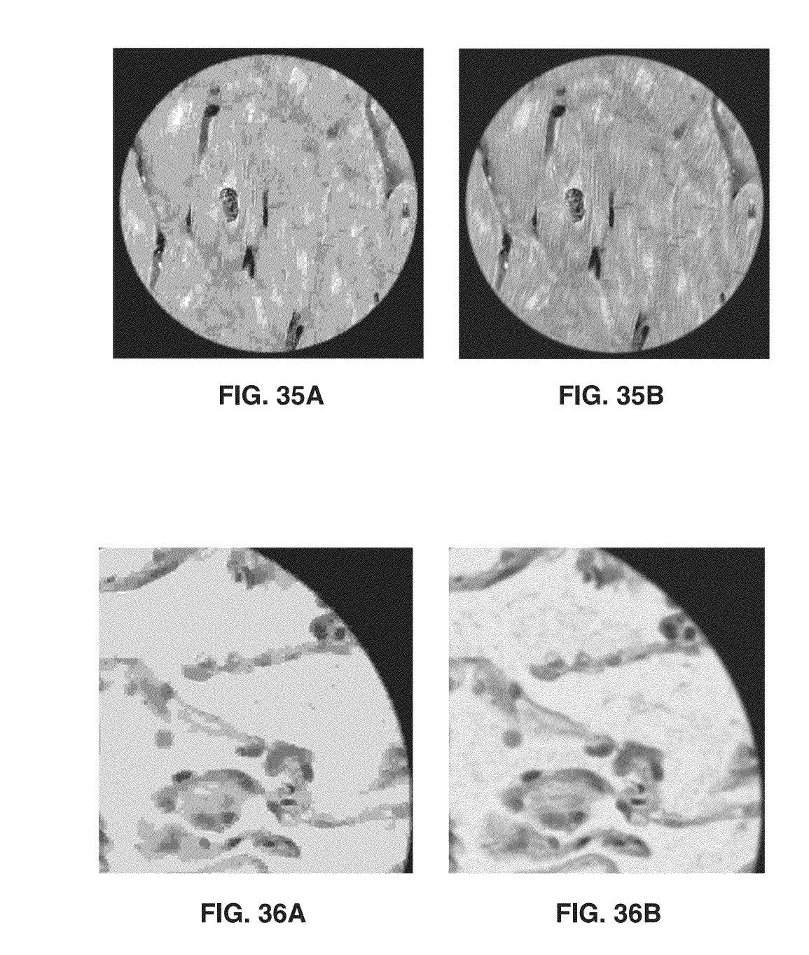

FIG. 35A and FIG. 35B are medical images of cardiac tissue comparing JPEG compression in FIG. 35A, with FSC+JPEG in FIG. 35B.

FIG. 36A and FIG. 36B are medical images of lung tissue comparing JPEG compression in FIG. 32A, with FSC+JPEG in FIG. 36B.

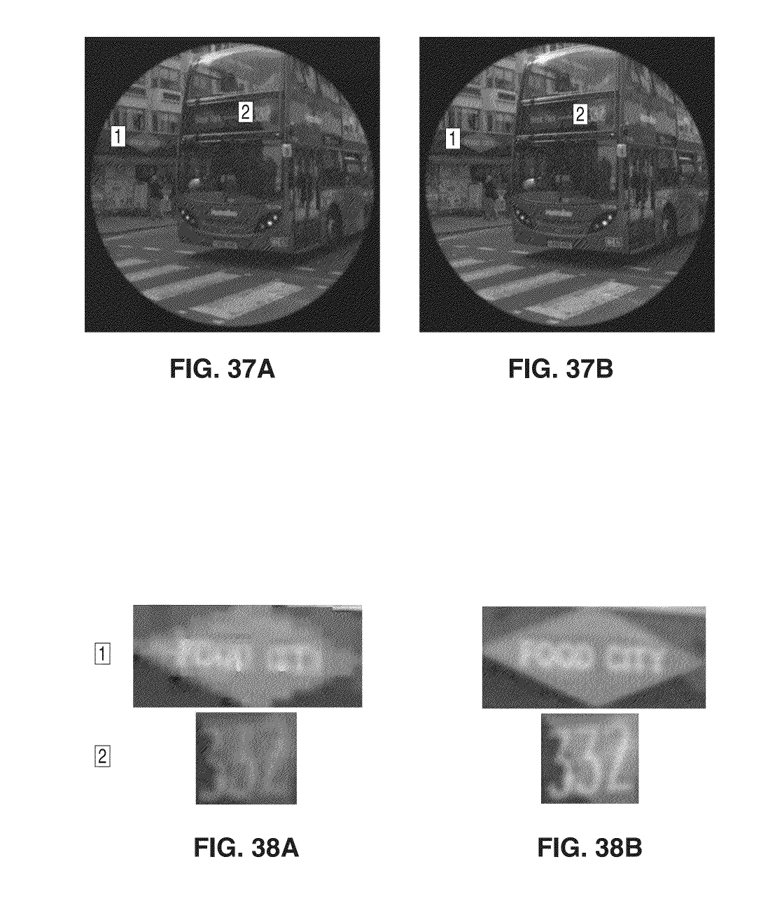

FIG. 37A and FIG. 37B are images of a double-decker bus comparing results after WebP compression in FIG. 37A, with feature selective compression (FSC) pre-compression utilized in combination with WebP compression in FIG. 37B.

FIG. 38A and FIG. 38B each contain two magnified image sections from compressed images of FIG. 37A and FIG. 37B, showing the increased readability provided utilizing FSC precompression.

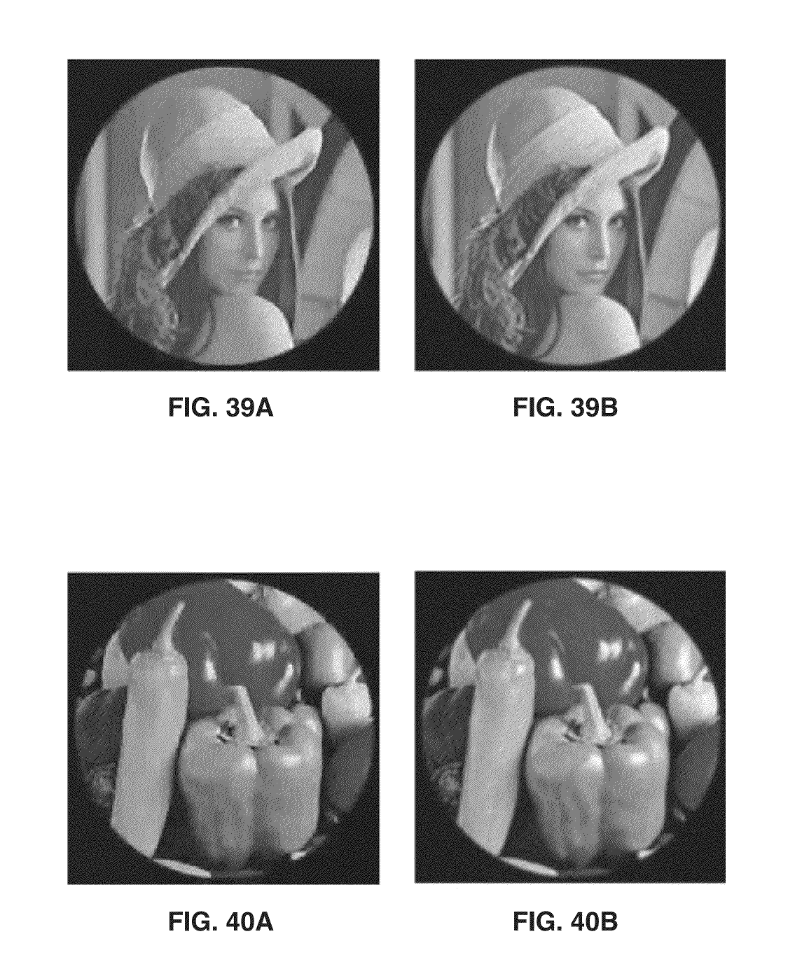

FIG. 39A and FIG. 39B are images of an actress comparing WebP compression in FIG. 39A, with FSC utilized in combination with WebP compression in FIG. 39B.

FIG. 40A and FIG. 40B are images of a group of peppers comparing WebP compression in FIG. 40A, with FSC utilized in combination with WebP compression in FIG. 40B.

In each of the above image examples one can readily discern the improved level of visual quality and readability provided by the inventive feature selective compression method utilized in combination with other compression techniques.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

From the discussion above it will be appreciated that the invention can be embodied in various ways, including the following:

1. A method for imaging an object with high spatial resolution: digitally imaging an object with a detector having a Fourier plane; and performing a transformation with a transformation stage, placed between an object being imaged and said detector, wherein said transformation imparts a nonlinear warp onto the spatial frequency spectrum of the image at the Fourier plane.

2. The method of any of the previous embodiments, wherein said transformation of the image is performed non-uniformly, warping the image, whereby in response to subsequent uniform sampling rate matches feature content of the image.

3. The method of any of the previous embodiments, wherein during said transformation of the image, more samples are assigned to sharp features with higher frequency contents of the image than to coarse features with lower frequency contents.

4. The method of any of the previous embodiments, wherein said transformation warps Fourier domain spectrum of the image according to a spectrum probability density function (SPDF).

5. The method of any of the previous embodiments, wherein said transformation performs mapping of signal spectrum and stretching it in space toward making mapping scale similar or equivalent for all features.

6. The method of any of the previous embodiments, wherein said transformation subjects the image to a filter with injective group delay corresponding to a phase response that depends on a combination of even-order powers of frequency, with weighting factors.

7. The method of any of the previous embodiments, wherein said transformation is performed in analog domain, digital domain, or a combination of analog and digital domains.

8. The method of any of the previous embodiments, wherein said transformation is performed in the digital domain utilizing digital signal processing.

9. The method of any of the previous embodiments, wherein said method reduces number of samples necessary for a given spatial bandwidth and field of view.

10. A method of feature selective image compression, comprising: reshaping an image in response to a stretch transform in which sharp features of the image are stretched to a greater extent than coarse features; and resampling the image; and allocating a higher number of samples to the sharp features to enhance image quality and fewer to coarse features where they are redundant.

11. The method of any of the previous embodiments, wherein the image comprises a monochrome or color image, or a series of monochrome or color images within video or streaming.

12. The method of any of the previous embodiments, wherein said feature selective image compression method is configured to allow image decompression to be performed in response to interpolation, followed by complex amplitude recovery and inverse reshaping.

13. The method of any of the previous embodiments, wherein said compression and associated decompression is performed in an analog domain, or an optical domain, or in a digital domain, or any combination of analog, optical and digital domains.

14. The method of any of the previous embodiments, wherein said stretch transform of said compression is performed in the optical domain prior to the image being received at an image sensor, and said method is configured to allow performing decompression in the optical domain after the image is projected.

15. The method of any of the previous embodiments, wherein said stretch transform of said compression is performed on digital data with digital signal processing.

16. The method of any of the previous embodiments, wherein said feature selective image compression is performed in real time for image compression.

17. The method of any of the previous embodiments, wherein said feature selective image compression increases field of view for a given number of pixels, or reduces number of pixels for a given field of view.

18. The method of any of the previous embodiments, further comprising performing a secondary form of image compression in combination with said feature selective image compression, toward improving image quality for a given compression factor, or providing a higher compression factor for a given image quality.

19. The method of any of the previous embodiments, wherein said second form of image compression comprises JPEG or WebP or compressive sensing.

20. The method of any of the previous embodiments, wherein said stretch transform is performed by reshaping the complex spectrum of the image using spatial digital phase filter with sublinear phase derivative versus frequency.

21. The method of any of the previous embodiments, wherein said sublinear phase derivative is an inverse tangent function of spatial frequency.

22. The method of any of the previous embodiments, wherein said spatial digital phase filter has a response determined by a modulation intensity distribution which is a distribution function that computes modulation spectrum of the image and its spatial size when the image is reshaped with an arbitrary phase operation.

23. The method of any of the previous embodiments: wherein said stretch transform is performed in response to reshaping the image in a spatial domain, by convolving the image with a function having superlinear dependence of phase derivative versus space coordinate; and wherein said convolving is followed by a nonlinear operation selected from a group of nonlinear operations which include computing the absolute value of the complex amplitude.

24. The method of any of the previous embodiments, wherein said function comprises a Fourier transform of a filter with inverse tangent phase derivative.

25. The method of any of the previous embodiments, wherein said method is configured for capture, storage and transmission of biomedical imaging or animated imaging.

26. The method of any of the previous embodiments, said biomedical imaging comprises histology, cytopathology, or angiography.

27. The method of any of the previous embodiments, wherein said method is configured for capture, storage and transmission of images for robotic microscopy, tele-pathology and tele-consultation.

28. The method of any of the previous embodiments, further comprising encryption of the image by securely maintaining a transfer function of said stretch transform to limit access to image recovery.

29. The method of any of the previous embodiments, wherein said method is utilized in magnetic resonance imaging (MRI), within 2D and 3D MRI, to reduce scan times, or increase resolution without increasing number of samples taken.

30. The method of any of the previous embodiments, wherein said method is utilized medical imaging to increase resolution, or lower image size.

31. The method of any of the previous embodiments, wherein said medical imaging is selected from the group of medical imaging fields consisting of scintigraphy, rapid angiography, whole-heart coronary imaging, enhanced brain imaging, and dynamic heart imaging.

32. A method of feature selective image decompression, comprising: receiving an image which has been compressed in response to reshaping in response to a stretch transform in which sharp features of the image are stretched to a greater extent than coarse features, followed by resampling the image to allocate a higher number of samples to the sharp features to enhance image quality and fewer to coarse features where they are redundant; performing interpolation on the compressed image; and performing complex amplitude recovery and inverse reshaping to complete decompression of the compressed image.

33. The method of any of the previous embodiments, wherein the image comprises a monochrome or color image, or a series of monochrome or color images within video or streaming.

34. The method of any of the previous embodiments, wherein said decompression is performed in an analog domain, or an optical domain, or in a digital domain, or any combination of analog, optical and digital domains.

35. The method of any of the previous embodiments, wherein the image which is received has been subject to a secondary form of image compression performed in combination with feature selective image compression; and further comprising performing a secondary form of image decompression which is the inverse of said secondary form of compression.

36. The method of any of the previous embodiments, wherein said secondary form of image compression comprises JPEG or WebP.

37. A system of feature selective image compression, comprising: a compressor configured for performing feature selective compression on an original image, comprising: reshaping the original image in response to a stretch transform in which sharp features of the image are stretched to a greater extent than coarse features; and resampling the image to output a compressed image; and wherein said compression allocates a higher number of samples to sharp features to enhance image quality, with fewer number of samples allocated to coarse features where they are redundant; a decompressor configured for performing decompression on said compressed image, comprising: performing interpolation on the compressed image; and performing complex amplitude recovery and inverse reshaping to output a reconstructed version of said original image.

38. The system of any of the previous embodiments, wherein the original image comprises a monochrome or color image, or a series of monochrome or color images within video or streaming.

39. The system of any of the previous embodiments, wherein said compression and associated decompression is performed in an analog domain, or an optical domain, or in a digital domain, or any combination of analog, optical and digital domains.

40. The system of any of the previous embodiments, further comprising performing a secondary form of image compression in combination with said feature selective image compression, and a secondary form of decompression as the inverse of said secondary image compression in combination with said decompression.

41. The system of any of the previous embodiments, wherein said second form of image compression, decompression comprises JPEG or WebP or compressive sensing.

42. The system of any of the previous embodiments, wherein said stretch transform is performed by reshaping the complex spectrum of the image using spatial digital phase filter with sublinear phase derivative versus frequency.

43. The system of any of the previous embodiments, wherein said sublinear phase derivative is an inverse tangent function of spatial frequency.

44. The system of any of the previous embodiments, wherein said spatial digital phase filter has a response determined by a modulation intensity distribution which is a distribution function that computes modulation spectrum of the image and its spatial size when the image is reshaped with an arbitrary phase operation.

45. The system of any of the previous embodiments, wherein said stretch transform is performed in response to reshaping the image in a spatial domain, by convolving the image with a function having superlinear dependence of phase derivative versus space coordinate; and wherein said convolving is followed by a nonlinear operation selected from a group of nonlinear operations including computing the absolute value of the complex amplitude.

46. The system of any of the previous embodiments, wherein said function comprises a Fourier transform of a filter with inverse tangent phase derivative.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for imaging an object with high spatial resolution, comprising:
digitally imaging an object with a detector having a Fourier plane; and
performing a transformation with a transformation stage, placed between an object being imaged and said detector, wherein said transformation imparts a nonlinear warp onto the spatial frequency spectrum of the image at the Fourier plane.

2. The method recited in claim 1, wherein said transformation of the image is performed non-uniformly, warping the image, whereby in response to subsequent uniform sampling rate matches feature content of the image.

3. The method recited in claim 1, wherein during said transformation of the image, more samples are assigned to sharp features with higher frequency contents of the image than to coarse features with lower frequency contents.

4. The method recited in claim 1, wherein said transformation warps Fourier domain spectrum of the image according to a spectrum probability density function (SPDF).

5. The method recited in claim 1, wherein said transformation performs mapping of signal spectrum and stretching it in space toward making mapping scale similar or equivalent for all features.

6. The method recited in claim 1, wherein said transformation subjects the image to a filter with injective group delay corresponding to a phase response that depends on a combination of even-order powers of frequency, with weighting factors.

7. The method recited in claim 1, wherein said transformation is performed in analog domain, digital domain, or a combination of analog and digital domains.

8. The method recited in claim 7, wherein said transformation is performed in the digital domain utilizing digital signal processing.

9. The method recited in claim 1, wherein said method reduces number of samples necessary for a given spatial bandwidth and field of view.

10. A method of feature selective image compression, comprising:
reshaping an image in response to a stretch transform in which sharp features of the image are stretched to a greater extent than coarse features; and
resampling the image; and allocating a higher number of samples to the sharp features to enhance image quality and fewer to coarse features where they are redundant.

11. The method recited in claim 10, wherein the image comprises a monochrome or color image, or a series of monochrome or color images within video or streaming.

12. The method recited in claim 10, wherein said feature selective image compression method is configured to allow image decompression to be performed in response to interpolation, followed by complex amplitude recovery and inverse reshaping.

13. The method recited in claim 12, wherein said compression and associated decompression is performed in an analog domain, or an optical domain, or in a digital domain, or any combination of analog, optical and digital domains.

14. The method recited in claim 13, wherein said stretch transform of said compression is performed in the optical domain prior to the image being received at an image sensor, and said method is configured to allow performing decompression in the optical domain after the image is projected.

15. The method recited in claim 12, wherein said stretch transform of said compression is performed on digital data with digital signal processing.

16. The method recited in claim 10, wherein said feature selective image compression is performed in real time for image compression.

17. The method recited in claim 10, wherein said feature selective image compression increases field of view for a given number of pixels, or reduces number of pixels for a given field of view.

18. The method recited in claim 10, further comprising performing a secondary form of image compression in combination with said feature selective image compression, toward improving image quality for a given compression factor, or providing a higher compression factor for a given image quality.

19. The method recited in claim 18, wherein said second form of image compression comprises JPEG or WebP or compressive sensing.

20. The method recited in claim 10, wherein said stretch transform is performed by reshaping the complex spectrum of the image using spatial digital phase filter with sublinear phase derivative versus frequency.

21. The method recited in claim 20, wherein said sublinear phase derivative is an inverse tangent function of spatial frequency.

22. The method recited in claim 20, wherein said spatial digital phase filter has a response determined by a modulation intensity distribution which is a distribution function that computes modulation spectrum of the image and its spatial size when the image is reshaped with an arbitrary phase operation.

23. The method recited in claim 10:
wherein said stretch transform is performed in response to reshaping the image in a spatial domain, by convolving the image with a function having superlinear dependence of phase derivative versus space coordinate; and
wherein said convolving is followed by a nonlinear operation selected from a group of nonlinear operations which include computing the absolute value of the complex amplitude.

24. The method recited in claim 23, wherein said function comprises a Fourier transform of a filter with inverse tangent phase derivative.

25. The method recited in claim 10, wherein said method is configured for capture, storage and transmission of biomedical imaging or animated imaging.

26. The method recited in claim 25, wherein said biomedical imaging comprises histology, cytopathology, or angiography.

27. The method recited in claim 10, wherein said method is configured for capture, storage and transmission of images for robotic microscopy, tele-pathology and tele-consultation.

28. The method recited in claim 10, further comprising encryption of the image by securely maintaining a transfer function of said stretch transform to limit access to image recovery.

29. The method recited in claim 10, wherein said method is utilized in magnetic resonance imaging (MRI), within 2D and 3D MRI, to reduce scan times, or increase resolution without increasing number of samples taken.

30. The method recited in claim 10, wherein said method is utilized in medical imaging to increase resolution, or lower image size.

31. The method recited in claim 30, wherein said medical imaging is selected from the group of medical imaging fields consisting of scintigraphy, rapid angiography, whole-heart coronary imaging, enhanced brain imaging, and dynamic heart imaging.

32. A method of feature selective image decompression, comprising:
receiving an image which has been compressed in response to reshaping in response to a stretch transform in which sharp features of the image are stretched to a greater extent than coarse features, followed by resampling the image to allocate a higher number of samples to the sharp features to enhance image quality and a fewer number of samples to coarse features where they are redundant;
performing interpolation on the compressed image; and
performing complex amplitude recovery and inverse reshaping to complete decompression of the compressed image.

33. The method recited in claim 32, wherein the image comprises a monochrome or color image, or a series of monochrome or color images within video or streaming.

34. The method recited in claim 32, wherein said decompression is performed in an analog domain, or an optical domain, or in a digital domain, or any combination of analog, optical and digital domains.

35. The method recited in claim 32:
wherein the image which is received has been subject to a secondary form of image compression performed in combination with feature selective image compression; and
further comprising performing a secondary form of image decompression which is the inverse of said secondary form of compression.

36. The method recited in claim 35, wherein said secondary form of image compression comprises JPEG or WebP.

37. A system of feature selective image compression, comprising:
a compressor configured for performing feature selective compression on an original image, comprising:
reshaping the original image in response to a stretch transform in which sharp features of the image are stretched to a greater extent than coarse features; and
resampling the image to output a compressed image;
wherein said compression allocates a higher number of samples to sharp features to enhance image quality, with fewer number of samples allocated to coarse features where they are redundant; and
a decompressor configured for performing decompression on said compressed image, comprising:
performing interpolation on the compressed image; and
performing complex amplitude recovery and inverse reshaping to output a reconstructed version of said original image.

38. The system recited in claim 37, wherein the original image comprises a monochrome or color image, or a series of monochrome or color images within video or streaming.

39. The system recited in claim 37, wherein said compression and associated decompression is performed in an analog domain, or an optical domain, or in a digital domain, or any combination of analog, optical and digital domains.

40. The system recited in claim 37, further comprising performing a secondary form of image compression in combination with said feature selective image compression, and a secondary form of decompression as the inverse of said secondary image compression in combination with said decompression.

41. The system recited in claim 40, wherein said second form of image compression, decompression comprises JPEG or WebP or compressive sensing.

42. The system recited in claim 37, wherein said stretch transform is performed by reshaping the complex spectrum of the image using spatial digital phase filter with sublinear phase derivative versus frequency.

43. The system recited in claim 42, wherein said sublinear phase derivative is an inverse tangent function of spatial frequency.

44. The system recited in claim 37, wherein said spatial digital phase filter has a response determined by a modulation intensity distribution which is a distribution function that computes modulation spectrum of the image and its spatial size when the image is reshaped with an arbitrary phase operation.

45. The system recited in claim 37:
wherein said stretch transform is performed in response to reshaping the image in a spatial domain, by convolving the image with a function having superlinear dependence of phase derivative versus space coordinate; and
wherein said convolving is followed by a nonlinear operation selected from a group of nonlinear operations including computing the absolute value of the complex amplitude.

46. The system recited in claim 45, wherein said function comprises a Fourier transform of a filter with inverse tangent phase derivative.
